(19) United States
(12) Patent Application Publication
(10) Pub. No.: US 2024/0072262 A1
(43) Pub. Date: Feb. 29, 2024

(54) CONSTRUCTION OF ELECTRODE AND CELL COMPONENTS FOR METAL-AIR BATTERIES

(71) Applicant: FORM ENERGY, INC., Somerville, MA (US)

(72) Inventors: Angel Ruben RIVERA, Watertown, MA (US); Kalina Chia-Shi YANG, Boston, MA (US); Katherine SPRIGGS, Boston, MA (US); Adrianna RODRIQUEZ, San Francisco, CA (US); Madeline Elliott PARKER, San Francisco, CA (US); Ryan HOWE, San Bruno, CA (US); Nicholas MCKIBBEN, Oakland, CA (US); Grant Harrison FRIESEN, Concord, CA (US); Jarrod David MILSHTEIN, Alameda, CA (US); Jhalak Joshipura VASAVADA, San Ramon, CA (US); Robert Wesley MORGAN, Winchester, MA (US); Erica Skye TRAINI, Cambridge, MA (US); Christopher Evan WOOD, Glenshaw, PA (US); Meghan Marya PATRICK, Boston, MA (US); Matthew DINITTO, Reading, MA (US)

(21) Appl. No.: 18/454,260

(22) Filed: Aug. 23, 2023

Related U.S. Application Data
(60) Provisional application No. 63/373,287, filed on Aug. 23, 2022.

(51) Int. Cl. H01M 4/86; H01M 12/08; H01M 50/105; H01M 50/121

(52) U.S. Cl. CPC H01M 4/8626; H01M 12/08; H01M 50/105; H01M 50/121

(57) ABSTRACT

According to an aspect, an electrochemical cell may include a vessel, at least two instances of an anode assembly, at least two instances of an oxygen evolution electrode (OEE), and a gas diffusion electrode (GDE). In the vessel, the GDE may be disposed between mirrored arrangements of the at least two instances of the OEE and the at least two instances of the anode assembly.

### CROSS-REFERENCE TO RELATED APPLICATIONS

This application claims the benefit of priority to U.S. Provisional Patent Application 63/373,287, filed Aug. 23, 2022, the entire contents of which are hereby incorporated herein by reference.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for increased availability, reliability, and/or resiliency with reduced costs in energy storage systems.

### SUMMARY

According to one aspect, an electrochemical cell may include a vessel, at least two instances of an anode assembly, at least two instances of an oxygen evolution electrode (OEE), and a gas diffusion electrode (GDE) wherein, in the vessel, the GDE is disposed between mirrored arrangements of the at least two instances of the OEE and the at least two instances of the anode assembly.

In some implementations, from one side of the vessel to another side of the vessel, the mirrored arrangements may include a first instance of the anode assembly, a first instance of the OEE, the GDE, a second instance of the OEE, and a second instance of the anode assembly.

In certain implementations, from one side of the vessel to another side of the vessel, the mirrored arrangements may include a first instance of the OEE, a first instance of the anode assembly, the GDE, a second instance of the anode assembly, and a second instance of the OEE.

In some implementations, the electrochemical cell may further include an electrolyte disposed in the vessel, wherein the at least two instances of the anode assembly, the at least two instances of the OEE, and the gas diffusion electrode are each at least partially immersed in the electrolyte in the vessel.

In certain implementations, the vessel may include a lid including a nested trough, bellows, a flange seal, a hot welded joint, and/or a laser welded joint.

In some implementations, the GDE may define an air passage between two faces of the GDE.

In certain implementations, the GDE may be a bifacial electrode sealed on three edges, and the bifacial electrode includes two electrode sheets and a flow field therebetween. For example, the flow field may include a stack of varying porosity foam, strips of filter felt, serpentine channels, folded channels, or a combination thereof. Further, or instead, the flow field may be mechanically and electrically separates two faces of the bifacial electrode. Still further, or instead, the electrochemical cell may include a bag of separator material, a one or more standoffs, and/or an electrode holder supporting the at least two instances of the anode assembly, the GDE, and the at least two instances of the OEE in the vessel.

In some implementations, the vessel may include an electronics structure providing distributed electrode switching.

In certain implementations, the vessel may include a cell demisting structure and/or a flame arrestor structure associated with a headspace of the vessel.

In some implementations, the at least two instances of the anode assembly may include metal stamped sheets.

In certain implementations, the at least two instances of the anode assembly, the at least two instances of the OEE, and the GDE may each be constrained from moving relative to one another in the vessel.

In some implementations, outer walls of the vessel may be formed by the at least two instances of the anode assembly.

In certain implementations, the vessel may include a plurality of ribs on outer walls of the vessel, the plurality of ribs spaced apart from one another to define a plurality of channels between successive ribs. For example, the plurality of channels may be of different heights ranging from a smaller height at a bottom portion of the vessel to a larger height at a top portion of the vessel. Further, or instead, the vessel may be formed from blow molded high density polyethylene (HDPE), acrylonitrile butadiene styrene (ABS), polypropylene (PP), or polyethylene terephthalate (PET).

In some implementations, the vessel may be a bag physically supported by a module into which the electrochemical cell is insertable.

In some implementations, the electrochemical cell may further include a separator, wherein the separator is a sheet disposed between one instance of the OEE and the GDE and/or between one instance of the OEE and one instance of the anode assembly. As an example, the sheet may be supported on one instance of the OEE.

In certain implementations, the electrochemical cell may be an iron-air type battery cell, zinc-air type battery cell, and/or lithium-air battery cell.

### DESCRIPTION OF THE DRAWINGS

FIG. 1 is a system block diagram of a power generation system according to various embodiments.

FIG. 2 is a system block diagram of a power generation system according to various embodiments.

FIG. 3 is a schematic representation of components of an electrochemical cell.

FIG. 4A is a perspective view of an outer portion of an electrochemical cell.

FIG. 4B is an exploded diagram of internal portions of the electrochemical cell of FIG. 4A.

FIG. 4C is a schematic representation of the arrangement of electrodes of the electrochemical cell shown in FIG. 4A.

FIG. 4D is a schematic representation of an arrangement of electrodes of an electrochemical cell, the arrangement of electrodes including a respective anode assembly between a respective oxygen evolution electrode (OEE) on either side of a gas diffusion electrode.

FIG. 5A is a schematic representation a module including a plurality of instances of electrochemical cells, with the schematic representation shown from an overhead view looking down the height (z dimension) of the plurality of instances of the electrochemical cells, and the plurality of electrochemical cells arranged in multiple rows from front to back of the module and with depth dimensions of each of the plurality of electrodes parallel with the side-to-side dimension of the module such that the plurality of electrochemical cells form a square footprint within the module.

FIG. 5B is a schematic representation of a module including a plurality of instances of electrochemical cells, with the schematic representation shown from an overhead view looking down the height (z dimension) of the plurality of instances of the electrochemical cells, and the plurality of electrochemical cells arranged in multiple rows from side-to-side of the module and with depth dimensions of each of the plurality of electrodes perpendicular to the side-to-side dimension of the module such that the plurality of electrochemical cells form a rectangular footprint within the module.

FIG. 5C is a schematic representation of a module including a plurality of instances of the electrochemical cells, with the schematic representation shown from an overhead view looking down the height (z dimension) of the plurality of instances of the electrochemical cells, the plurality of electrochemical cells arranged as a single row and with depth dimensions of the plurality of electrochemical cells perpendicular to the side-to-side dimension of the module such that the plurality of electrochemical cells form a rectangular footprint within the module.

FIG. 5D is a schematic representation of a module including a plurality of instances of the electrochemical cells, with the schematic representation shown from an overhead view looking down the height (z dimension) of the plurality of instances of the electrochemical cells, the plurality of electrochemical cells arranged as multiple rows from side-to-side with depth dimensions of each of the plurality of electrodes perpendicular to the side-to-side dimension of the module such that the plurality of electrochemical cells form a square footprint of the module.

FIG. 6A is a perspective view of an enclosure for one or more instances of the module of FIG. 5.

FIG. 6B is a perspective view of the enclosure of FIG. 6A, shown with doors removed.

FIG. 6C is a perspective view of a lower structure of the enclosure of FIG. 6A.

FIG. 7A is schematic representation of a top-down view of an enclosure, shown with an auxiliary area within the enclosure and co-located with a plurality of instances of a module.

FIG. 7B is a schematic representation of a top-down view of a system including enclosures, each enclosure supporting a plurality of instances of modules, and each enclosure supported by a shared auxiliary area.

FIG. 7C is a schematic representation of a top-down view of a system including enclosures, each enclosure having an auxiliary area therein, and each enclosure connected to a shared auxiliary area.

FIGS. 8A-8E are schematic representations of example layouts of a plurality of instances of module within an enclosure.

FIGS. 9A-9F are schematic representations of example layouts of a plurality of instances of a module within an enclosure.

FIGS. 10A-10E are schematic representations of example layouts of a plurality of instances of a module within an enclosure.

FIG. 11A is a schematic representation of a top view of a sealed passthrough of a lid of the electrochemical cell of FIG. 4A.

FIG. 11B is a schematic representation of a cross-section of the sealed passthrough in the lid shown in FIG. 11A, with the cross-section taken along the line 11B-11B in FIG. A.

FIG. 11C is a schematic representation of bellows sealing of the lid of the electrochemical cell of FIG. 4A.

FIG. 12A is a front view of a portion of an air electrode of the electrochemical cell of FIG. 4A.

FIG. 12B is a close-up, perspective view of a portion of the air electrode along the area of detail 12B in FIG. 12A.

FIGS. 13A-13B are a schematic representations of exemplary processes for pressing an air flow field in place during seal lamination of an electrode.

FIG. 14 is a schematic representation of an exemplary method for inserting a flow field into a pre-formed bifacial sealed electrode to form an electrode.

FIG. 15A is a schematic representation of a low pressure, high uniformity flow field using porous media for an electrode of an electrochemical cell.

FIG. 15B shows simulation results of a flow field along a long, narrow active area of an electrode, with the flow field formed using two symmetrical opposing strips of filter felt with a tapered geometry to balance pressure drop across the inlet to the outlet of the electrode.

FIG. 15C is a schematic representation of a flow field along a long, narrow active area of an electrode, with the flow field formed using a vertical feed and laterally positioned porous media strips to control and distribute air flow.

FIG. 15D shows simulation results of a flow field along a long, narrow active area of an electrode, with the flow field formed using horizontal serpentine channels of varying heights.

FIG. 15E shows simulation results of a flow field along a long, narrow active area of an electrode, with the flow field formed using vertical serpentine channels fed by a vertical inlet extending from a top of the flow field to a bottom of the flow field.

FIG. 15F is a schematic representation a long, narrow active area of an electrode including accordion folds of increasing height from top to bottom to form a flow field.

FIG. 15G is a schematic representation of a long, narrow active area of an electrode including a ladder structure of increasing spacing from top to bottom of the electrode.

FIG. 16 is a perspective view of a module including a plurality of instances of an electrochemical cell separated by bags and in which structural support is provided at the level of the module.

FIG. 17 is a schematic representation of a cathode including a separator.

FIG. 18A is a perspective view of the electrochemical cell of FIG. 4A, showing a top-down cross-section A-A along the electrochemical cell of FIG. 4A.

FIG. 18B is a top-down view of a cross-section of the electrochemical cell of FIG. 4A, with the cross-section taken along A-A in FIG. 18A.

FIG. 19 is a schematic representation of aspects of an electrode holder holding electrodes of an electrochemical cell.

FIG. 20A is a schematic representation of aspects of separating two electrodes with a mesh standoff.

FIG. 20B is a schematic representation of aspects of separating two electrodes with a corrugated standoff.

FIG. 21 is a schematic representation of methods to reduce the ohmic drop along the electrode height and improve current uniformity in plane of the electrode in accordance with various embodiments.

FIG. 22 is a schematic representation of methods for anode current collection.

FIG. 23A is a top view of an electrode switching control device including a single centralized switch on a printed circuit board.

FIGS. 23B-D are schematic representations of various aspects of an electrode switching control device including multiple switches in parallel on a printed circuit board and distributed across the width of an electrochemical cell.

FIGS. 24A-25H are schematic representations of aspects of cell demisting, flame arresting, and hydrogen management in accordance with various embodiments.

FIGS. 26A-C are schematic representations of aspects of anode assemblies.

FIGS. 27A-D are schematic representations of aspects of lid-to-vessel sealing.

FIG. 28 is a schematic representation of aspects of an anode operating as a primary structural member for an electrochemical cell.

FIG. 29 is a schematic representation of anodes used as vessels for electrochemical cells.

FIG. 30 is a schematic representation of thermal management of a module using forced air cooling between electrochemical cells.

FIG. 31 is a schematic representation of aspects of a vessel of an electrochemical cell.

FIG. 32 illustrates aspects of an example blow molded cell vessel in accordance with various embodiments.

FIG. 33 shows computational fluid dynamics/finite element analysis simulation results of air flow across the blow molded cell vessel of FIG. 32

FIG. 34 is a perspective view of a vessel defining curved channels.

FIG. 35 is a schematic representation of serial airflow across a module of electrochemical cells.

FIG. 36 is a schematic representation of a parallel flow configuration of stacked instances of the vessel in a row within a module.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments is not intended to be limiting and, instead, is intended to enable a person skilled in the art to make and use these embodiments or combinations thereof.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the disclosure provided herein. Thus, the scope of the present disclosure should not be limited to a particular embodiment, configuration or arrangement that is set forth in a particular embodiment, example, or in an embodiment in a particular figure.

Embodiments of the present disclosure may include systems, methods, and devices for electrochemical energy storage systems, such as metal-air battery systems. Systems and methods of the various embodiments may provide for construction and configuration of electrodes and/or cell components of metal-air battery systems.

Various embodiments may provide devices and/or methods for use in long-duration, and ultra-long-duration, low-cost, energy storage, including in multi-day energy storage. Herein, “long duration” and “ultra-long duration” and similar such terms, unless expressly stated otherwise, should be given their broadest possible meaning and include periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include long duration energy storage (LODES) systems. Further, the terms “long duration” and “ultra-long duration”, “energy storage cells” including “electrochemical cells”, and similar such terms, unless expressly stated otherwise, should be given their broadest possible interpretation; and include electrochemical cells that may be configured to store energy over time spans of days, weeks, or seasons, such as electrochemical cells sometimes referred to as multi-day energy storage (MDS) cells. As a matter of definition, the term “duration” means the ratio of energy to power of an energy storage system. For example, a system with a rated energy of 24 MWh and a rated power of 8 MW has a duration of 3 hours; a system with a rated energy of 24 MWh and a rated power of 1 MW has a duration of 24 hours. Physically, this may be interpreted as the run-time at maximum power for the energy storage system.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Various embodiments may provide devices and/or methods for use in bulk energy storage systems, such as long duration energy storage (LODES) systems (e.g., multi-day energy storage (MDS) systems), short duration energy storage (SDES) systems, etc. As an example, various embodiments may provide configurations and controls for batteries of bulk energy storage systems, such as batteries for LODES systems.

While various examples are discussed with reference to Li-ion and/or Fe-air, the discussion of Li-ion and/or Fe-air is used merely as an example and various embodiments encompass other combinations and permutations of storage technologies that may be substituted for the example solar+Li-ion+Fe-air discussions herein. For example, various metal-air storage technologies may be used as batteries in the various embodiments, such as Zinc-air, lithium-air, sodium-air, etc.

As used herein, the term “module” may refer to a string of unit electrochemical cells (e.g., a string of batteries). Multiple modules (or multiple units or electrochemical cells) may be connected together to form battery strings.

Unless otherwise expressed or made clear from the context, the recitation of any element in the singular shall be understood to be intended to encompass embodiments including one or more of such elements and the separate recitation of “one or more” is generally omitted for the sake of clarity and readability. Thus, for example, recitation of a LODES system 104 shall be understood to be inclusive of one or more LODES systems, etc.

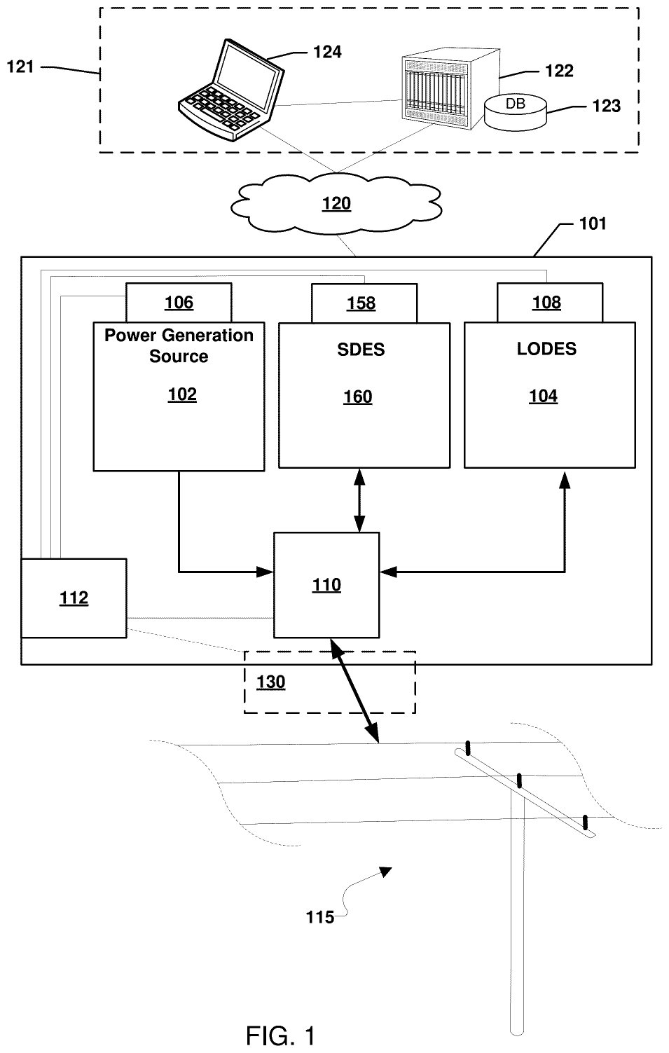

FIG. 1 is a system block diagram of a power generation system 101 according to various embodiments. The power generation system 101 may be a power plant including a power generation source 102, a LODES systems 104 (e.g., a multi-day energy storage (MDS) system), and an SDES systems 160. As examples, the power generation source 102 may include renewable power generation sources, non-renewable power generation sources, combinations of renewable and non-renewable power generation sources, etc. Examples of the power generation sources 102 include wind generators, solar generators, geothermal generators, nuclear generators, etc. The LODES system 104 may include an electrochemical cell (e.g., one or more batteries). The batteries of the LODES systems 104 may be any type of battery, such as rechargeable secondary batteries, refuellable primary batteries, combinations of primary and secondary batteries, etc. Battery chemistries may be any suitable chemistry, such as Al, AlCl₃, Fe, FeOₓ (OH)_{y}, NaₓS_{y}, SiOₓ(OH)_{y}, AlOₓ(OH)_{y}, metal-air, and/or any suitable type of battery chemistry. The SDES systems 160 may include one or more electrochemical cells (e.g., one or more batteries). The batteries of the SDES systems 160 may be any type of battery, such as rechargeable secondary batteries, refuellable primary batteries, combinations of primary and secondary batteries, etc. Battery chemistries may be any suitable chemistry, such as Li-ion, Na-ion, NiMH, Mg-ion, and/or any suitable type of battery chemistry.

In various embodiments, the operation of the power generation source 102 may be controlled by a first control system 106. The first control system 106 may include motors, pumps, fans, switches, relays, or any other type of devices that may control the generation of electricity by the power generation source 102. In various embodiments, the operation of the LODES system 104 may be controlled by a second control system 108. The second control system 108 may include motors, pumps, fans, switches, relays, or any other type of devices that may control the discharge and/or storage of electricity by the LODES system. In various embodiments, the operation of the SDES system 160 may be controlled by a third control system 158. The third control system 158 may include motors, pumps, fans, switches, relays, or any other type of devices that may control the discharge and/or storage of electricity by the SDES system 160. The first control system 106, the second control system 108, and the third control system 158 may each be connected to a plant controller 112. The plant controller 112 may monitor the overall operation of the power generation system 101 and generate and send control signals to the first control system 106, the second control system 108, and the third control system 158 to control the operations of the power generation source 102, the LODES system 104, and/or the SDES system 160.

In the power generation system 101, the power generation source 102, the LODES system 104, and the SDES system 160 may each be connected to a power control device 110. The power control device 110 may be connected to a power grid 115 or other transmission infrastructure. The power control device 110 may include switches, inverters (e.g., AC to DC inverters, DC to AC inverters, etc.), relays, power electronics, and any other type of devices that may control the flow of electricity from to/from the power generation source 102, the LODES system 104, the SDES system 160, and/or the power grid 115. Additionally, or alternatively, the power generation system 101 may include transmission facilities 130 connecting the power generation, transmission, and the power generation system 101 to the power grid 115. As an example, the transmission facilities 130 may connect between the power control device 110 and the power grid 115 such that electricity may flow between the power generation system 101 and the power grid 115. Transmission facilities 130 may include transmission lines, distribution lines, power cables, switches, relays, transformers, and any other type of devices that may support the flow of electricity between the power generation system 101 and the power grid 115. The power control device 110 and/or the transmission facilities 130 may be connected to the plant controller 112. The plant controller 112 may monitor and control the operations of the power control device 110 and/or the transmission facilities 130, such as via various control signals. As examples, the plant controller 112 may control the power control device 110 and/or the transmission facilities 130 to provide electricity from the power generation source 102 to the power grid 115, to provide electricity from the LODES system 104 to the power grid 115, to provide electricity from both the power generation source 102 and the LODES system 104 to the power grid 115, to provide electricity from the power generation source 102 to the LODES system 104, to provide electricity from the power grid 115 to the LODES system 104, to provide electricity from the SDES system 160 to the power grid 115, to provide electricity from both the power generation source 102 and the SDES system 160 to the power grid 115, to provide electricity from the power generation source 102 to the SDES system 160, to provide electricity from the power grid 115 to the SDES system 160, to provide electricity from the SDES system 160 and the LODES system 104 to the power grid 115, and/or to provide electricity from the power generation source 102, the SDES system 160, and the LODES system 104 to the power grid 115. In various embodiments, the power generation source 102 may selectively charge the LODES system 104 and/or SDES system 160 and the LODES system 104 and/or SDES system 160 may selectively discharge to the power grid 115. In this manner, energy (e.g., renewable energy, non-renewable energy, etc.) generated by the power generation source 102 may be output to the power grid 115 sometime after generation from the LODES system 104 and/or the SDES system 160.

In various embodiments, the plant controller 112 may be in communication with a network 120 (e.g., 3G network, 4G network, 5G network, core network, Internet, combinations of the same, etc.). Using the connections to the network 120, the plant controller 112 may exchange data with the network 120 as well as with devices connected to the network 120, such as a plant management system 121 or any other device connected to the network 120. The plant management system 121 may include one or more computing devices, such as a computing device 124 and a server 122. The computing device 124 and the server 122 may be connected to one another directly and/or via connections to the network 120. The various connections to the network 120 by the plant controller 112 and devices of the plant management system 121 may be wired and/or wireless connections.

In various embodiments, the computing device 124 of the plant management system 121 may provide a user interface that facilitates providing user-defined inputs to the plant management system 121 and/or to the power generation system 101, receiving indications associated with the plant management system 121 and/or with the power generation system 101, and/or otherwise controlling operation of the plant management system 121 and/or the power generation system 101.

While shown as two separate devices, 124 and 122, the functionality of the computing device 124 and server 122 described herein may be combined into a single computing device or may split among more than two devices. Additionally, or alternatively, while shown as part of the plant management system 121, the functionality of one or both the computing device 124 and the server 122 may be entirely, or partially, carried out by a remote computing device, such as a cloud-based computing system. Further, or instead, while shown as being in communication with a single instance of the power generation system 101, the plant management system 121 may be in communication with multiple instances of the power generation system 101.

While shown as being located together in FIG. 1, the power generation source 102, the LODES system 104, and the SDES system 160 may be physically separated from one another in various implementations. For example, the LODES system 104 may be downstream of a transmission constraint, such as downstream of a portion of the power grid 115, downstream from the power generation source 102 and SDES system 160, etc. In this manner, the overbuild of underutilized transmission infrastructure may be reduced, or even avoided, by situating the LODES system 104 downstream of a transmission constraint, charging the LODES system 104 at times of available capacity and discharging the LODES system 104 at times of transmission shortage. The LODES system 104 may also, or instead, arbitrate electricity according to prevailing market prices to reduce the final cost of electricity to consumers.

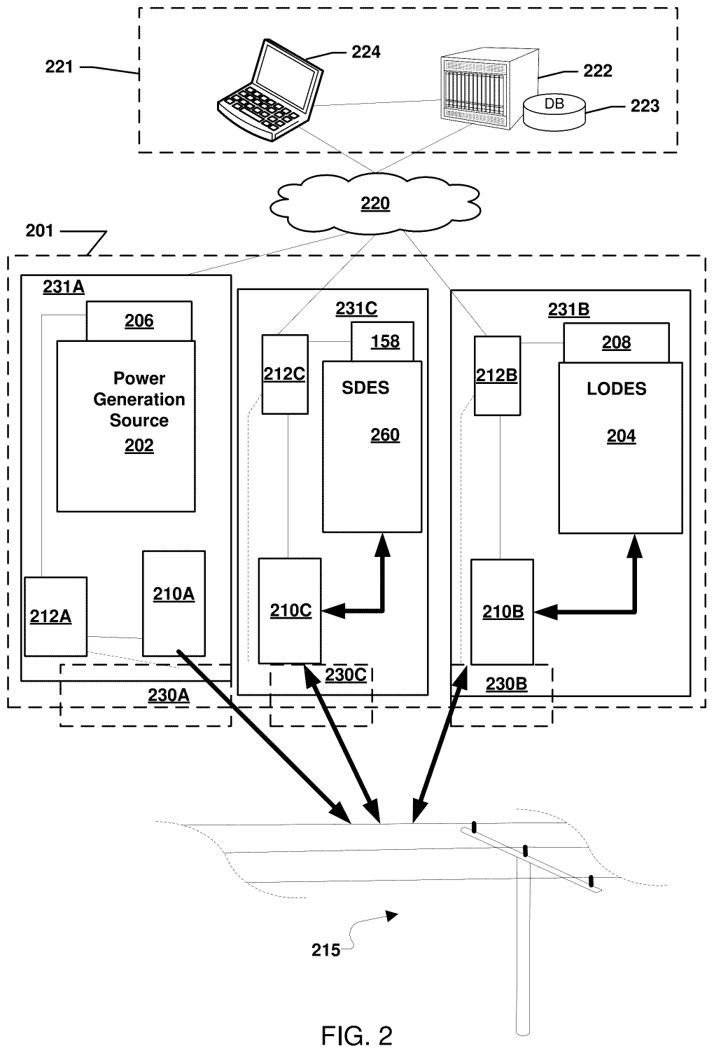

FIG. 2 is a system block diagram of a power generation system 201 in which various elements of the power generation system 201 may be physically separated from one another according to various embodiments. For the sake of clear and efficient description, elements in FIG. 2 with numbers having the same last two digits as in FIG. 1 shall be understood to be analogous to or interchangeable with one another, unless otherwise specified or made clear from the context, and, therefore, are not described separately from one another, except to note differences and/or to emphasize certain features. For example, the power generation system 101 (FIG. 1) shall be understood to be analogous to and/or interchangeable with the power generation system 201, unless a contrary intent is expressed or made clear from the context.

As an example, the power generation system 201 may include a power generation source 202 and one or more bulk energy storage systems, such as a LODES system 204 and/or an SDES system 260. The power generation source 202, the LODES system 204, and/or the SDES system 160 may be separated in the power plants 231A, 231B, 231C, respectively. While the power plants 231A, 231B, 231C may be separated from one another, the power generation system 201 and a plant management system 121 may operate as described above with reference to operation of the power generation system 101 and the plant management system 121 (FIG. 1). While the power plants 231A, 231B, and 231C may be co-located or may be geographically separated from one another. The power plants 231A, 231B, and 231C may connect to the power grid 215 at different places. For example, the power plant 231A may be connected to the power grid 215 upstream of where the power plant 231B is connected.

In some implementations, the power plant 231A associated with the power generation source 202 may include dedicated equipment for the control of the power plant 231A and/or for transition of electricity to/from the power plant 231A. For example, the power plant 231A may include a plant controller 212A and a power controller 110A and/or a transmission facility 230A. The power controller 210A and/or the transmission facility 230 may be connected in electrical communication with the plant controller 112A. The plant controller 212A may, for example, monitor and control the operations of the power controller 210A and/or the transmission facility 230A, such as via various control signals. As examples, the plant controller 212A may control the power controller 210A and/or transmission facility 230A to provide electricity from the power generation sources 202 to the power grid 215, etc.

Additionally, or alternatively, the power plant 231B associated with the LODES system 204 may include dedicated equipment for the control of the power plant 231B and/or for transmission of electricity to/from the power plant 231B. For example, the power plant 231B associated with the LODES system 204 may include a plant controller 112B, a power controller 210B, and/or a transmission facility 230B. The power controller 210B and/or the transmission facility 230B may be connected to the plant controller 212B. The plant controller 212B may monitor and control the operations of the power controller 210B and/or of the transmission facility 230B, such as via various control signals. As an example, the plant controller 212B may control the power controller 210B and/or the transmission facility 230B to provide electricity from the LODES system 204 to the power grid 215 and/or to provide electricity from the power grid 215 to the LODES system 204, etc.

Still further, or instead, the power plant 231C associated with the SDES system 260 may include dedicated equipment for the control of the power plant 231C and/or for transmission of electricity to/from the power plant 231C. For example, the power plant 231C associated with the SDES system 260 may include a plant controller 212C and a power controller 210C and/or a transmission facility 230C. The power controller 210C and/or the transmission facility 230C may be connected to the plant controller 212C. The plant controller 212C may monitor and control the operations of the power controller 210C and/or transmission facility 230C, such as via various control signals. As examples, the plant controller 212C may monitor and control the operations of the power controller 210C and/or transmission facility 230C, such as via various control signals. As examples, the plant controller 212 may control the power controller 210C and/or the transmission facility 230C to provide electricity from the SDES system 260 to the power grid 215 and/or to provide electricity from the power grid 215 to the SDES system 260, etc.

In various embodiments, the plant controllers 212A, 212B, 212C may each be in communication with each other and/or with a network 220. Using the connections to the network 220, the plant controllers 212A, 212B, 212C may exchange data with the network 220 as well as with one or more devices connected to the network 220, such as a plant management system 221, each other, or any other device connected to the network 220. In various embodiments, the operation of the plant controllers 212A, 212B, 212C may be monitored by the plant management system 221 and the operation of the plant controllers 212A, 212B, 212C—and, thus, operation of the power generation system 201, may be controlled by the plant management system 221.

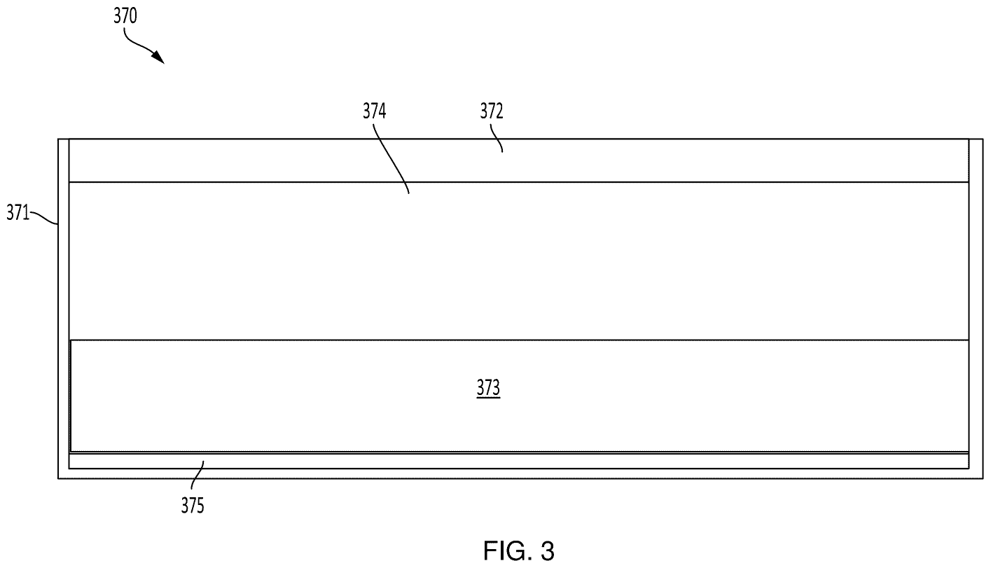

FIG. 3 is a schematic view of a battery 370 that may be used in the one or more LODES systems described herein (e.g., the LODES system 204 in FIG. 1 and/or the LODES system 204 in FIG. 2). The battery 370 may include a vessel 371, a gas diffusion electrode (GDE) 372, an anode 373, an electrolyte 374, and a current collector 375. The GDE 372, the anode 373, the electrolyte 374, and the current collector 375 may each be disposed in the vessel 371. The anode 373 may include a metal electrode (e.g., an iron electrode, a lithium electrode, a zinc electrode, or other type of suitable metal). The electrolyte 374 may separate the GDE 372 from the anode 373. Additionally, specific examples of batteries, such as batteries similar to battery 370, that may be used in bulk energy storage systems, such as in LODES systems of the present disclosure are described in U.S. Pat. App. Pub. 2021/0028457, the entire contents of which are incorporated herein by reference. As examples, the battery 370 may be a metal-air type battery, such as an iron-air battery, a lithium-air battery, a zinc-air battery, etc. While various examples are discussed with reference to metal-air batteries, other type batteries may be additionally, or alternatively, used in the various examples provided herein unless otherwise specified or made clear from the context. The battery 370 may be a single cell or unit, and multiple instances of the battery 370—namely, multiple units or cells—may be connected together to form a module. Multiple modules may be connected to one another to form a battery string.

In various embodiments, the anode 373 may be solid and the electrolyte may be excluded from the anode. In various embodiments the anode 373 may be porous and the electrolyte 374 may be interspersed geometrically with the anode 373, creating a greater interfacial surface area for reaction. Further, or instead, the air electrode 203 may be porous and the electrolyte 374 may be interspersed geometrically with the anode 373, creating a greater interfacial surface area for reaction. Still further, or instead, the GDE 372 may be at an interface of the electrolyte 374 and a gaseous headspace (not shown in FIG. 3). The gaseous headspace may, for example, be sealed in a housing. Additionally, or alternatively, the housing may be unsealed and the gaseous headspace may be an open system which can freely exchange mass with the environment.

The anode 373 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.) that can undergo an oxidation reaction for discharge. As such, the anode 373 may be referred to as a metal electrode herein.

In certain embodiments, the battery 370 may be rechargeable and the anode 373 may undergo a reduction reaction when the battery 370 is charged. The anode 373 may be a solid, including a dense or porous solid, or a mesh or foam, or a particle or collection of particles, or may be a slurry, ink, suspension, or paste deposited within the housing. In various embodiments, composition of the anode 373 may be selected such that the anode 373 and the electrolyte 374 do not mix together to any substantial extent, allowing for only small amounts of solubility that do not impact performance of the battery 370. For example, the anode 373 may be a metal electrode that may be a bulk solid. Further, or instead, the anode 373 may include a collection of particles, such as small or bulky particles, within a suspension, and the collection of particles may not be buoyant enough to escape the suspension into the electrolyte 374. Additionally, or alternatively, the anode 373 may include particles that are not buoyant in the electrolyte 374.

The GDE 372 may support the reaction with oxygen. As an example, the GDE 372 may be a solid and may sit at the interface of a gas headspace and the electrolyte 374. During the discharge process, the GDE 372 may support the reduction of oxygen from the gaseous headspace, in a reaction known as the Oxygen Reduction Reaction (ORR). In certain embodiments, the battery 370 may be rechargeable and the reverse reaction may occur—namely, the reaction in which the GDE supports the evolution of oxygen from the battery, in a reaction known as Oxygen Evolution Reaction (OER). The OER and ORR reactions are commonly known to those skilled in the art.

In various embodiments, the electrolyte 374 may be a liquid electrolyte. For example, the electrolyte 374 may be an aqueous solution, a non-aqueous solution, or a combination thereof. In various embodiments, the electrolyte 374 may be an aqueous solution which may be acidic (low-pH), neutral (intermediate pH), or basic (high pH; also called alkaline or caustic). In certain embodiments, the electrolyte 374 may comprise an electropositive element, such as Li, K, Na, or combinations thereof. In some embodiments, the liquid electrolyte may be basic, namely with a pH greater than 7. In some embodiments the pH of the electrolyte may be greater than 10 (e.g., greater than 12). For example, the electrolyte 374 may include a 6M (mol/liter) concentration of potassium hydroxide (KOH). In certain embodiments, the electrolyte 374 may include a combination of ingredients such as 5.5M potassium hydroxide (KOH) and 0.5M lithium hydroxide (LiOH). In certain embodiments, the electrolyte 374 may comprise a 6M (mol/liter) concentration of sodium hydroxide (NaOH). In certain embodiments, the electrolyte 374 may comprise a 5M (mol/liter) concentration of sodium hydroxide (NaOH) and 1M potassium hydroxide (KOH).

In certain embodiments, the battery 370 (e.g., metal-air battery) may discharge by reducing oxygen (O₂) typically sourced from air. This may achieved by a triple-phase contact between gaseous oxygen, an electronically active conductor which supplies the electrons for the reduction reaction, and the electrolyte 374 which contains the product of the reduction step. For example, in certain embodiments involving an aqueous alkaline electrolyte, oxygen from air may be reduced to form hydroxide ions through the half-reaction O₂+2H₂O+4e⁻→4OH⁻. Thus, oxygen delivery to metal-air cells may include gas handling and maintenance of triple-phase points. In certain embodiments, sometimes referred to as “normal air-breathing” configurations, the GDE 372 may be positioned at the gas-liquid interface to promote and maintain triple-phase boundaries. The GDE 372 may be positioned vertically or horizontally, or at any intermediate angle with respect to gravity, and maintain a “normal air-breathing” configuration. In these “normal air-breathing” configurations, the gas phase is at atmospheric pressure—that is, gas phase is unpressurized beyond the action of gravity.

The battery 370 in FIG. 3 is merely an example of one electrochemical cell according to various embodiments and is not intended to be limiting. Other configurations, such as electrochemical cells with different types of vessels and/or without the vessel 371, electrochemical cells with different types of air electrodes and/or without the GDE 372, electrochemical cells with different types of current collectors and/or without the current collector 375, electrochemical cells with different types of anodes and/or without the anode 373, and/or electrochemical cells with different types of electrolytes and/or electrochemical cells without the electrolyte 374 may be substituted for the example configuration of the battery 370, and other arrangements are in accordance with the various embodiments.

In various embodiments, the vessel 371 may be made from a polymer such as polyethylene, acrylonitrile butadiene styrene (ABS), high-density polyethylene (HDPE), ultra-high molecular weight polyethylene (UHMW), polypropylene, and/or other polymers. In certain embodiments, the vessel 371 and/or housing for the battery 370 may be made from a metal such as nickel, steel, anodized aluminum, nickel coated steel, nickel coated aluminum or other metal.

In various embodiments, a battery (e.g., the battery 370) may include three electrodes—an anode (e.g., the anode 373) and a dual cathode (e.g., GDE 372 including two parts, such as a first cathode, and a second cathode). The electrodes may have finite useful lifetimes, and may be mechanically replaceable. For example, the anode may be replaced seasonally. The first cathode of the dual cathode may be divided into two portions, a first portion having a hydrophilic surface and a second portion having a hydrophobic surface. For example, the hydrophobic surface may have a polytetrafluorethylene (PTFE) (e.g., Teflon®) hydrophobic surface.

For example, the second portion having the hydrophobic surface may include a microporous layer of polytetrafluorethylene (PTFE) and high surface area carbon while the first portion having the hydrophilic surface may include carbon fiber partially coated with PTFE. As another example, the second portion may include a microporous layer of PTFE and carbon black and the first portion may include PTFE of approximately 33% by weight. As a further example, the second portion may include a microporous layer of 23% by weight PTFE and 77% by weight carbon black and the first portion may include a low loading microporous layer. The anode may be an iron (Fe) electrode or an iron-alloy (Fe-alloy) electrode (e.g., FeAl, FeZn, FeMg, etc.). The second cathode of the dual cathode may include a hydrophilic surface. The second cathode of the dual cathode may include a metal substrate, such as carbon (C), titanium (Ti), steel, etc., coated with nickel (Ni). Electrolyte (e.g., electrolyte 140) may be disposed between the three electrodes. The electrolyte may be infiltrated into one or more of the three electrodes.

Battery systems may include a number of cells connected in series and/or parallel in a shared electrolyte bath and contained in a housing.

Referring now to FIGS. 1-4C, FIG. 4A an electrochemical cell 400 may include at least one battery, such as at least one instance of the battery 200, in accordance with various embodiments. In some implementations, the electrochemical cell 400 may include a vessel 401 (e.g., such as the vessel 371), in which an air electrode (e.g., a cathode), such as the GDE 372, a negative electrode (e.g., an anode), such as the anode 373, and an electrolyte, such as the electrolyte 374, are disposed. The electrolyte, such as the electrolyte 374, may rise to a given level within the vessel 401 and a headspace between the top of the vessel 401 and electrolyte level may be formed in the electrochemical cell 400. The vessel 401 may have a height (e.g., a z dimension), a width (e.g., a y dimension), and a depth (e.g., a x dimension). In one example configuration, the height may be greater than the width and depth and the width may be greater than the depth such that the vessel 401 is a generally rectangular cuboid. The vessel 401 may include one or more various connections, such as electrical connections, electrolyte connections, gas connections (e.g., air connections), vents, etc. Via the connections, two or more electrochemical cells (e.g., two or more instances of the electrochemical cell 400) may be connected together, such as in series and/or in parallel, to form a module.

In a module formed of a plurality of instances of the electrochemical cell 400, each instance of the electrochemical cell 400 may be a self-contained unit supporting its own respective air electrode (e.g., the GDE 372), anode electrode (e.g., the anode 373), and electrolyte (e.g., the electrolyte 374). The module structure may support the vessel 401 of the electrochemical cells 400 disposed within the given module.

The vessel 401 may have disposed within it one or more instances of an anode assembly 402a,b (e.g., one or more instances of the anode 373), one or more instances of a cathode (e.g., the air electrode 203), and an electrolyte (e.g., the electrolyte 374). As an example, each instance of the cathode assembly may include a respective instance of an Oxygen Evolution Electrode (OEE) 403a,b and a gas diffusion electrode (GDE) 404. A battery including at least one instance of the OEE 403 and at least one instance of the GDE 404 may be referred to as a multi-cathode battery cell.

A first OEE 403a may be disposed within the vessel 401, between a first anode assembly 402a and the GDE 404. On the opposite side of the GDE 404, a second OEE 403b and a second anode assembly 402b may be in a mirror configuration relative to the GDE 404. That is, within the vessel 401, the GDE 404 may be disposed between symmetric arrangements of: 1) the first anode assembly 402a and the first OEE 403a; and 2) the second anode assembly 402b and the second OEE 403b. As a specific example, the GDE 404 may be disposed centrally within a volume defined by the vessel 401, such that the length and width of the GDE 404 is at least partially disposed along a center plane defined by the length and width of the volume defined by the vessel 401 and intersecting a midpoint of the depth dimension of the volume defined by the vessel 401. Air may enter the volume of the vessel 401 and pass into the GDE 404 (e.g., into a center portion of the GDE 404) between the first OEE 403a and the second OEE 403b. The electrochemical cell 400 may include first standoff elements 451 between the first anode assembly 402a and the first OEE 403a and between the second anode assembly 402b and the second OEE 403b. Further, or instead, the electrochemical cell 400 may include second standoff elements 452 between the first OEE 403a and the GDE 404 and between the second OEE 403b and the GDE 404. However, such internal arrangement of the electrochemical cell 400 is merely one example configuration within the vessel 401, and is not intended to be limiting.

In some implementations, the electrochemical cell 400 may include an electronics structure 450, which may include a printed circuit board assembly (PCBA), circuitry housing, etc., as may be useful for supporting various electronic devices (e.g., controllers, sensors, switches, wiring buses, etc.) that may control and/or manage one or more operations of the electrochemical cell 400. The electrochemical cell 400 may additionally, or alternatively, include a lid 455 and an electrode holder 454 on opposite sides along a length dimension of the vessel 401. Straps 453 may secure the lid 455 and the electrode holder 454 to the vessel 401. The electronics structure 450 may be supported on the lid 455 in some configurations.

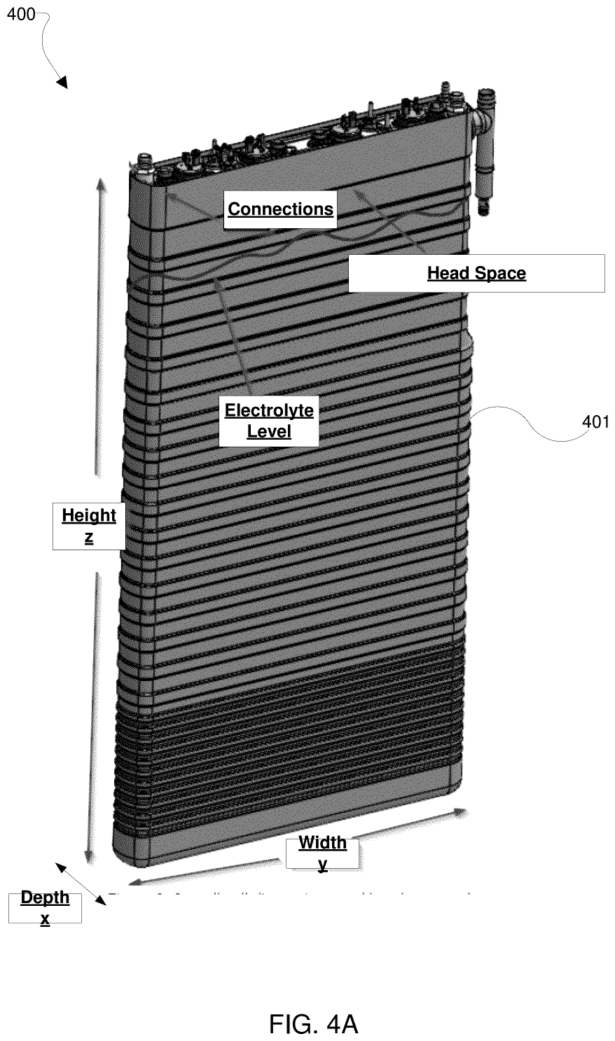

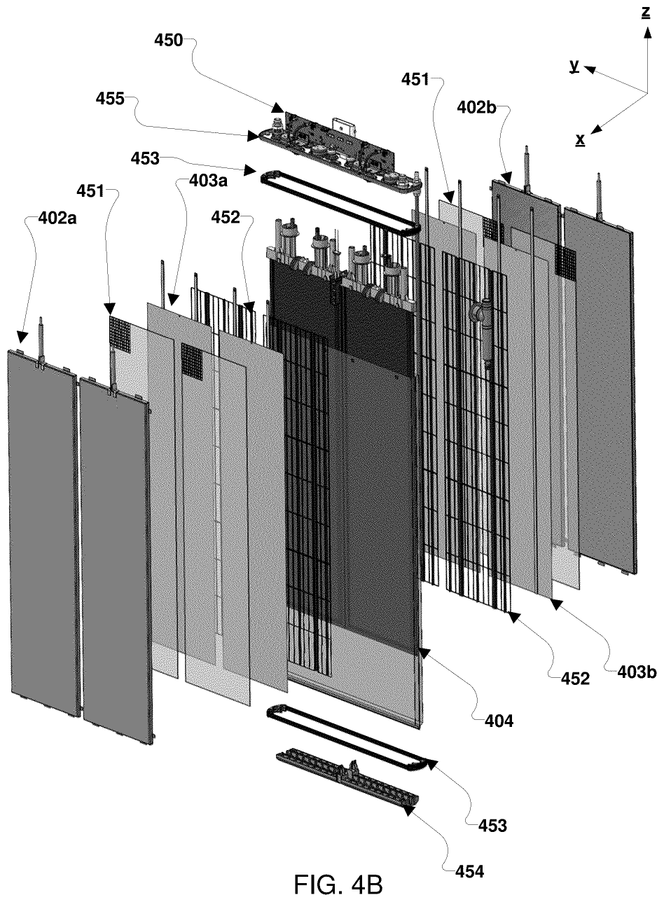

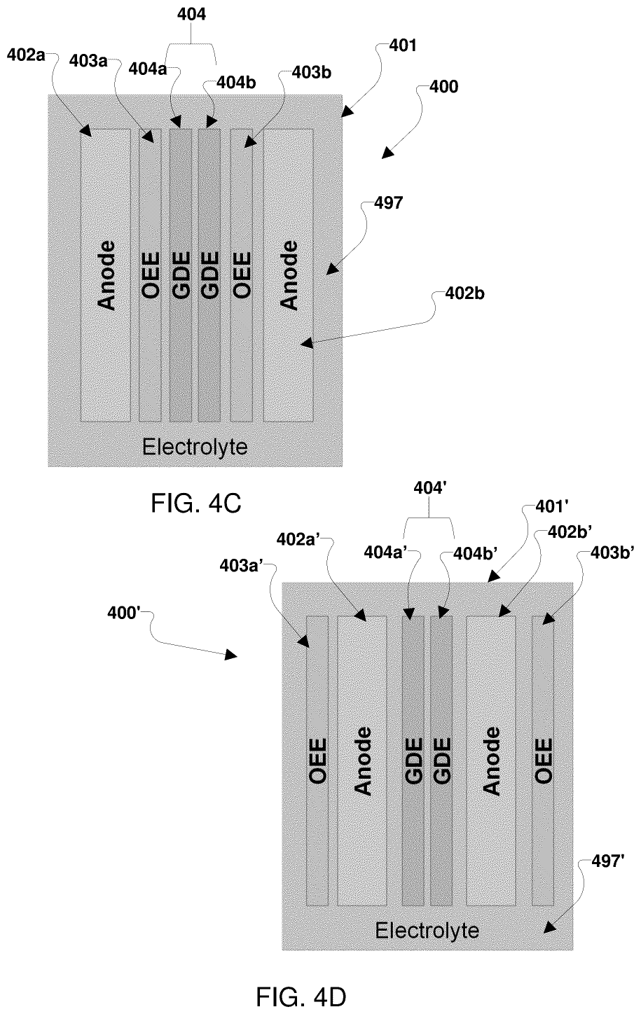

In general, the first OEE 403a, the first anode assembly 402a, the GDE 404, the second OEE 403b, and the second anode assembly 402b may each be disposed in an electrolyte 497 within the volume of the vessel 401 of the electrochemical cell 400. As discussed herein, the GDE 404 may include a two part electrode with two faces sealed on three-sides to form a two-faced pocket construction defining a central air passage between the two faces. As compared to other configurations, the amount of inactive material used in construction of the GDE 404 (e.g. flowfield, epoxy “trough” or frame) may be reduced by making a 2-sided GDE (air in the middle with active faces on either side). To facilitate construction of the GDE 404, the first anode assembly 402a and the first OEE 403a may be mirrored about the GDE 404 by the second anode assembly 402b and the second OEE 403b. Along the depth dimension of the vessel 401, in a direction from right to left in FIG. 4C, a construction of electrodes within the vessel 401 of the electrochemical cell 400 may be: the first anode assembly 402a|the first OEE 403a|a first portion 404a of the GDE 404|a second portion 404b of the GDE 404|the second OEE 403b|the second anode assembly 402b. For ease of manufacturing and assembly, each electrode may be further divided into two mechanically distinct electrodes across the width dimension of the vessel 401—thus resulting in the electrochemical cell having 4 anodes (e.g., two instances of the first anode assembly 402a and two instances of the second assembly 402b), 4 OEEs (e.g., two instances of the first OEE 403a and two instances of the second OEE 403b), and two instances of the GDE 404. Electrically and electrochemically, all electrodes may function as a parallel circuit (e.g. common potential among all anodes).

With reference to FIGS. 1-4C and 5A, a module 501 is shown from an overhead view looking down the height (e.g., z dimension) of a plurality of instances of the electrochemical cell 400. The module 501 may be a generally square configuration with the front, back, and sides of the module 501 about the same lengths. In the module 501, the plurality of instances of the electrochemical cell 400 may be arranged in two rows such that the respective width dimensions of the plurality of instances of the electrochemical cell are parallel to the sides of the module 501 and the respective depths of the vessel 401 run parallel to the front and back of the module 501. In the configuration of the module 501, the combined width of the two rows of the plurality of instances of the electrochemical cell 400, along with any spacing between the two rows and the front and the back of the module, may generally govern the length of each side of the module 501. The number of instances of the electrochemical cell 400 in each row and the depth dimension of each instance of the vessel 401, along with the spacing between the instances of the vessel 401 in each row and the spacing of the respective rows from the sides of the module 501, may generally govern the length from the front to the back of the module 501. As described in greater detail below, other arrangements of a plurality of instances of the electrochemical cells 400 are additionally, or alternatively, possible to form modules with other footprints.

While various aspects of electrochemical cells and modules of such electrochemical cells have been described, it shall be appreciated that other implementations are additionally or alternatively possible.

For example, while the electrochemical cell 400 has been described as including one type of mirrored arrangement of anode assemblies and OEEs relative to the GDE 404, it shall be appreciated that another type of mirrored arrangement is additionally or alternatively possible. For example, referring now to FIG. 4D, along a depth dimension of a vessel 401′ in a direction from left to right in FIG. 4D, a construction of electrodes within the vessel 401′ of an electrochemical cell 400′ may be: a first OEE 403a′|a first anode assembly 402a′|the first portion 404a′ of the GDE 404′|the second portion 404b of the GDE 404′ la second anode assembly 402b land a second OEE 403b′. In this context, element numbers designated with a prime (′) shall be understood to be identical to corresponding element numbers that are unprimed, except to the extent necessary to accommodate the different positioning of electrodes in FIG. 4D relative to the positioning shown in FIGS. 4B and 4C. Further, or instead, the electrochemical cell 400′ shall be understood to be interchangeable with the electrochemical cell 400 in the description that follows. However, for the sake of clear and efficient description, the description, reference in the description that follows is made only to the electrochemical cell 400.

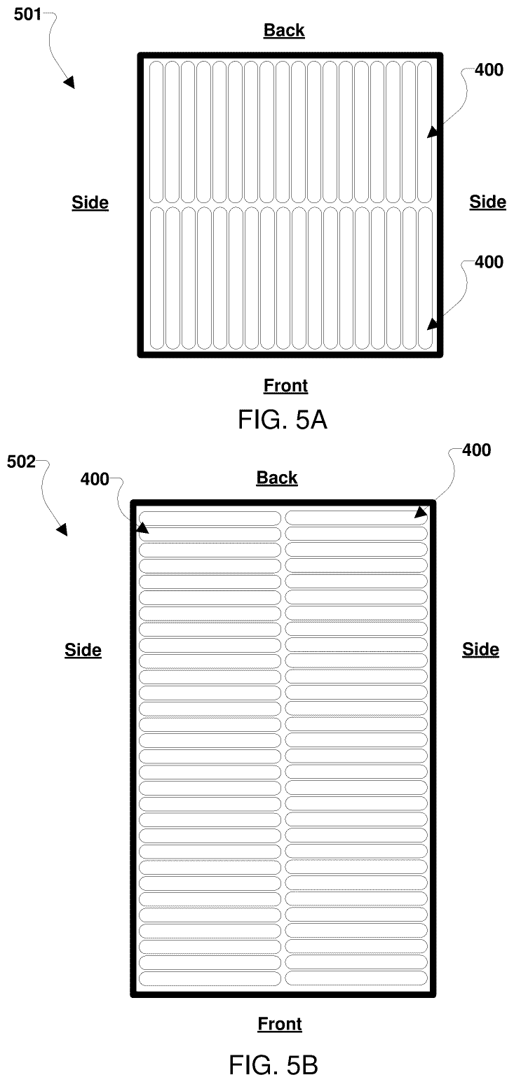

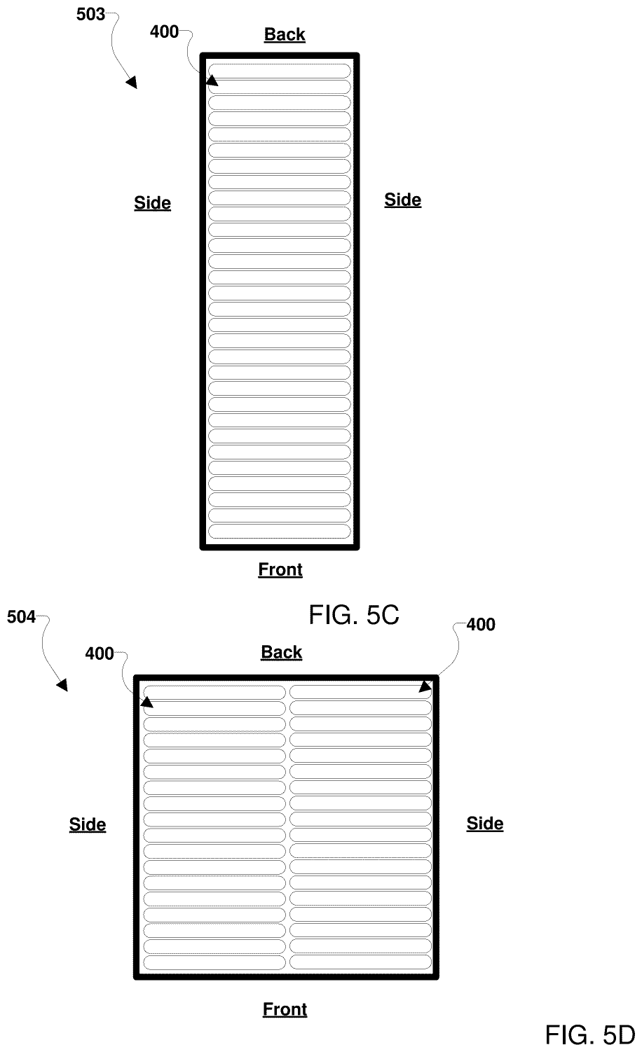

As another example, while the module 501 has been described as having a particular arrangement of electrochemical cells to form a particular footprint, it shall be appreciated that other arrangements of electrochemical cells are additionally or alternatively possible to form modules. As an example, referring now to FIG. 5B, a module 502 configuration may include multiple instances of the electrochemical cell 400 in accordance with various embodiments. The module 502 configuration may be a generally rectangular configuration with the sides of the module 502 longer than the back and front of the module 502. In the module 502, two rows of instances of the electrochemical cell 400 may be arranged such that the widths of the plurality of instances of the electrochemical cell 400 are parallel to the front and back of the module 502 and the depths of the plurality of instances of the electrochemical cell 400 are parallel to the sides of the module 502. In the configuration of the module 502, the widths of two instances of the electrochemical cell 400 may generally govern the length of the front and back of the module 502 along with any spacing between the rows of instances of the electrochemical cell 400 and spacing of the respective rows and the sides of the module 502. The number of instances of the electrochemical cell 400 in each row and the depth of the plurality of instances of the electrochemical cells 400 may generally govern the length of the sides of the module 502 along with the spacing between the plurality of instances of the electrochemical cells 400 in each row and the spacing of the respective rows and the front and back of the module 502.

As another example, referring now to FIG. 5C, a module 503 configuration may include multiple instances of the electrochemical cell 400 in accordance with various embodiments. The module 503 may be a generally rectangular configuration with the sides of the module 503 longer than the back and front of the module 503. In the module 503, a single row of instances of the electrochemical cell 400 may be arranged such that the widths of the instances of the electrochemical cell 400 are parallel to the front and back of the module 503 and the depths of the instances of the electrochemical cell 400 are parallel to the sides of the module 502. In the module 503, the widths of the single row of instances of the electrochemical cell 400 may generally govern the length of the front and back of the module 503 along with any spacing between the sides of the module 503. The number instances of the electrochemical cell 400 in the row and the depth of the instances of the electrochemical cell 400 may generally govern the length of the sides of the module 503 along with the spacing between the instances of the electrochemical cell 400 in the row and the spacing between the front and back of the module 503.

As yet another example, referring now to FIG. 5D a module 504 may be generally square with the front, back, and sides of the module 504 about the same lengths. In the module 504, two rows of instances of the electrochemical cell 400 may be arranged such that the widths of the instances of the electrochemical cell 400 are parallel to the front and back of the module 504 and the depths of the instances of the electrochemical cell 400 are parallel to the sides of the module 504. In the module 504, the widths of the two instances of the electrochemical cell 400 may generally govern the length of the front and back of the module 504 along with any spacing between the rows of instances of the electrochemical cell 400 and spacing of the respective rows and the sides of the module 504. The number of instances of the electrochemical cell 400 in each row and the depths of the instances of the electrochemical cell 400 may generally govern the length of the sides of the module 504 along with the spacing between the instances of the electrochemical cell 400 in each row and the spacing of the respective rows and the front and back of the module 504.

Other configurations, of a plurality of instances of the electrochemical cell are additionally or alternatively possible, such as modules with more or fewer rows, modules with non-linear arrangements of electrochemical cells, modules with more or fewer electrochemical cells, etc., may be substituted for the example configuration of the modules described above and other configurations are in accordance with the various embodiments.

In various embodiments, battery modules having strings of electrochemical cells therein may be enclosed in an enclosure. The enclosure may house one or more instances of a module, with each instance of a module having strings of electrochemical cells therein. In description that follows, enclosures are described with respect to a plurality of instances of the module 501 (FIG. 5A). It shall be appreciated, however, that this is for the sake of clear and efficient description. That is, unless otherwise indicated or made clear from the context, any reference the module 501 (FIG. 5A) in enclosures shall be understood to apply equally to any other arrangement of electrochemical cells in a module and, thus, shall be understood to apply equally to the module 502 (FIG. 5B), to the module 503 (FIG. 5C), and to the module 504 (FIG. 5D).

Instances of the module 501 deployed in the field may need protection from the elements, such as: wind, dust, snow, rain, seismic activity, etc. The instances of the module 501 may also, or instead, need to be secured to the ground to reduce the likelihood of movement in the event of heavy winds and/or seismic activity. Personnel also need to have protections from high voltage, caustic fluids, and any other hazardous conditions associated with the operation of a battery system. There are several auxiliary systems that may also be required to support operating the battery energy storage system, including secondary containment, thermal management, hydrogen management, gas diffusion electrode (GDE) support, air supply, electrolyte/water management, etc.

Referring now to FIGS. 1-5A and 6A-6C, one or more instances of the module 501 may be positioned in the enclosure 605. As an example, the enclosure 605 may include a lower structure 602, walls 603, 604, 606, 607, a roof 611, and doors 612, 614.

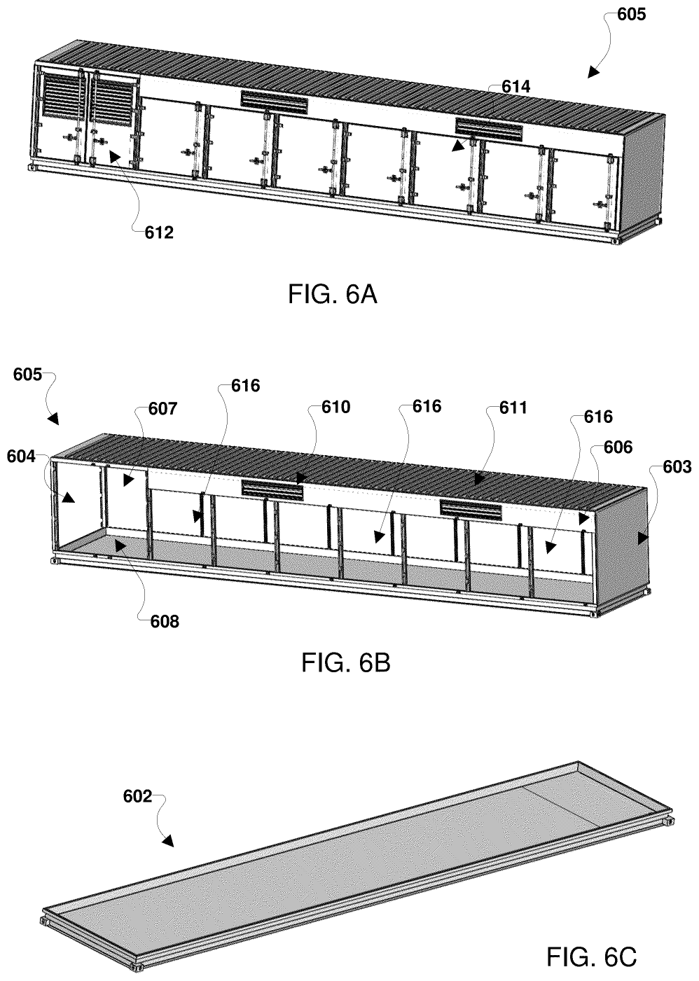

In some implementations, the lower structure 602 may support the entire weight of the plurality of instances of the module 501 for transport and installation. A secondary containment may be fabricated into the lower structure 602, for example to handle both the potential for a spill and fire water if it is incorporated in the design. Lifting points may be provided in the lower structure 602 such that the lower structure 602 may be lifted either by the corners or have additional pick points incorporated along its length. The base of the lower structure 602 may include attachment points to facilitate securing the one or more instances of the module 501 to the enclosure 605, for example to support shipping, seismic event dampening, etc. To facilitate protecting the one or more instances of the module 501 as installed and/or during transport, the enclosure 605 may include doors 612 and 614. Additionally, other doors and/or hatches may be installed along other walls and/or the roof of the enclosure 605. The configuration of the enclosure 605 shown in FIGS. 6A-6C shows a configuration for at least seven modules, but it shall be appreciated that more or fewer modules may be present in the enclosure 605 depending on enclosure size and/or configuration. Still further, or instead, the enclosure 605 may include mounting points provided to attach to a variety of field installation structures, such as grade beams, piles, helical piers, foundations, etc., upon deployment in the field.

In some embodiments, the enclosure 605 may include an auxiliary area 608. As an example, the auxiliary area 608 may be at one end of the enclosure 605. Further, or instead, auxiliary equipment may be mounted in the auxiliary area to support operation of the one or more instances of the modules 501. Auxiliary equipment may include, pumps, blowers, controllers, switches, connections, tubing, ducting, heaters, chillers, filters, reservoirs, tanks, electronics, or any other type of equipment that may support the operation of the one or more instances of the module 501 within the enclosure 605. The support subsystems may be housed in the auxiliary area 608 and connected to the one or more instances of the module 501. The support subsystems may include GDE air systems, thermal management systems, heating systems, hydrogen management systems, water and/or electrolyte management systems, power electronics systems, controls electronics systems, communication systems, telemetry sensors and equipment, and/or disconnects from plant level services, as well as any other type of subsystems. Further, or instead, the floor of the enclosure 605 may define perforations to allow for stub ups of electrical, water, or any other desired connection to be made upon installation in the field. The perforation may maintain the secondary containment requirements of the lower structure 602.

The walls 603, 604, 606, and 607 may be attached to the lower structure 602 and, in some instances, may support snow loads taken up by the roof 611 and/or may handle wind loads upon the enclosure 605. The structural shell formed by the walls 603, 604, 506, and 607 attached to the lower structure 602 may further, or instead, may provide mounting for auxiliary subsystems that need to be run throughout the enclosure 605 to support operation of the one or more instances of the module 501. While the walls 603, 604, 606, and 607 and the roof 611 may each be metal in some instances, it shall be appreciated that all or portions of the walls 603, 604, 606, and 607 and/or the roof 611 may be formed from other materials, such as fabric, cloth, etc.

In various implementations, the enclosure 605 may be formed into different areas, such as the auxiliary area 608 and module bays 616. In various embodiments, the auxiliary area 608 may be covered by the door 612 on one or both long sides of the enclosure 605, and the module bays 616 may be covered by doors 614 on one or both long sides of the enclosure 605. The doors 612 and/or 614 may facilitate access to the auxiliary equipment and/or to one or more instances of the module 501 for maintenance, repair, and/or replacement. In some embodiments, perforations 610 may be defined by the walls 606 and/or by the roof 611 to facilitate exchanging air from ambient to the enclosure 605 and vice versa. The perforations 610 may include, for example, filter grates. Further, or instead, the enclosure 605 may maintain low dust intrusion and/or protect against driven rain.

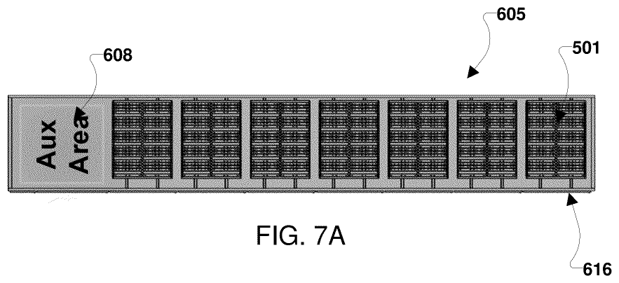

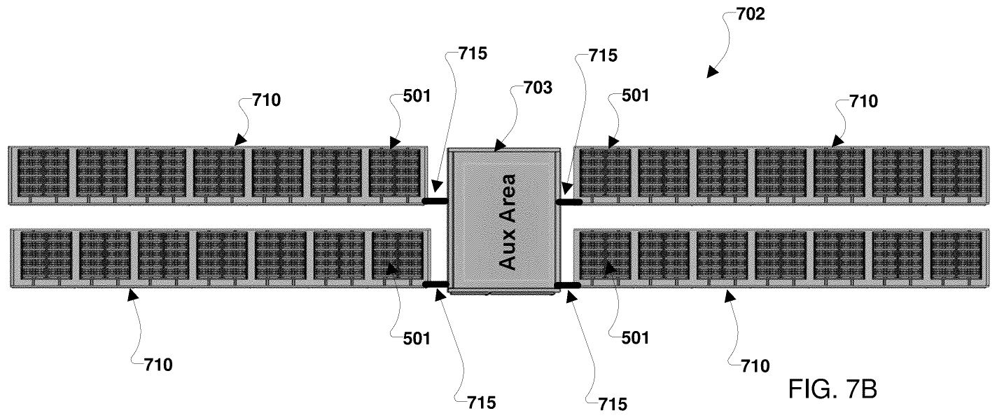

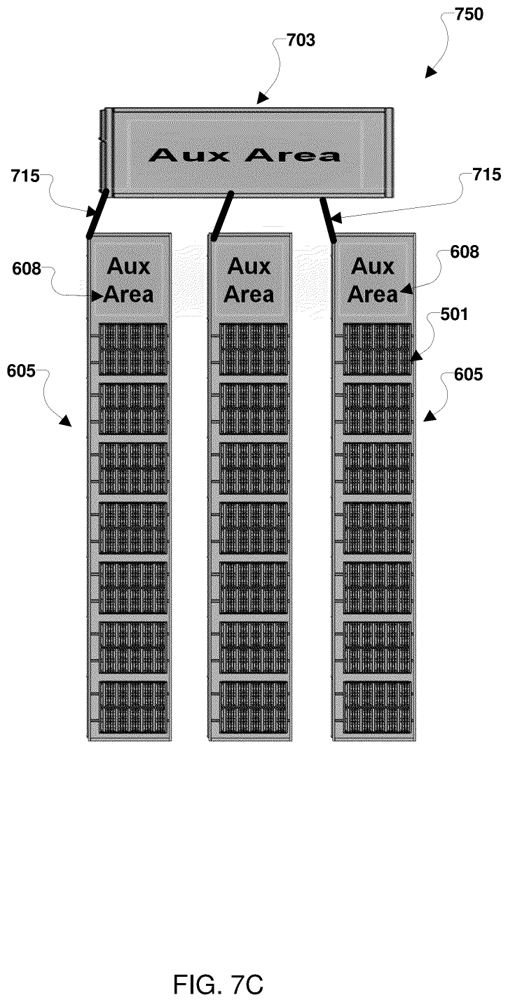

Referring now to FIG. 7A, an auxiliary area 608 may be within the enclosure 605 and co-located with the one or more instances of the module 501 within the module bays 616. While the enclosure 605 is shown as including seven instances of the module 501, it shall be appreciated that more or fewer instances of the module 501 may be disposed in the enclosure 605, as may be useful for accommodating different end-use cases.

Referring now to FIG. 7B, a system 702 may include a plurality of instances of an enclosure 710 supporting a plurality of instances of the module 501. A shared auxiliary area 703 may support the plurality of instances of the enclosure 710. The shared auxiliary area 703 may be connected to each of the plurality of instances of the module 501 by one or more connections 715 and the shared auxiliary area 703 may feed the subsystem services, such as those of GDE air systems, thermal management systems, hydrogen management systems, water and/or electrolyte management systems, power electronics systems, controls electronics systems, telemetry sensors and equipment, and/or disconnects from plant level services, as well as any other type subsystems, to the plurality of instances of the enclosure 710 and the plurality of instances of the module 501 therein. While four instances of the enclosure 710 are shown in FIG. 7B, more or fewer instances of the enclosure 710 may be connected to the shared auxiliary area 703 and the shared auxiliary area 703 may be sized according to the number of enclosures to support and number of modules within the enclosures.

Referring now to FIG. 7C, a system 750 may include the shared auxiliary area 703 enclosure is connected to a plurality of instances of the enclosure 605, with each instance of the enclosure 605 having the auxiliary area 608 therein. In this manner, some auxiliary system functions may be in whole, or in part, offloaded to the shared auxiliary area 705 and some auxiliary system functions may in whole, or in part, be at the level of the enclosure 605.

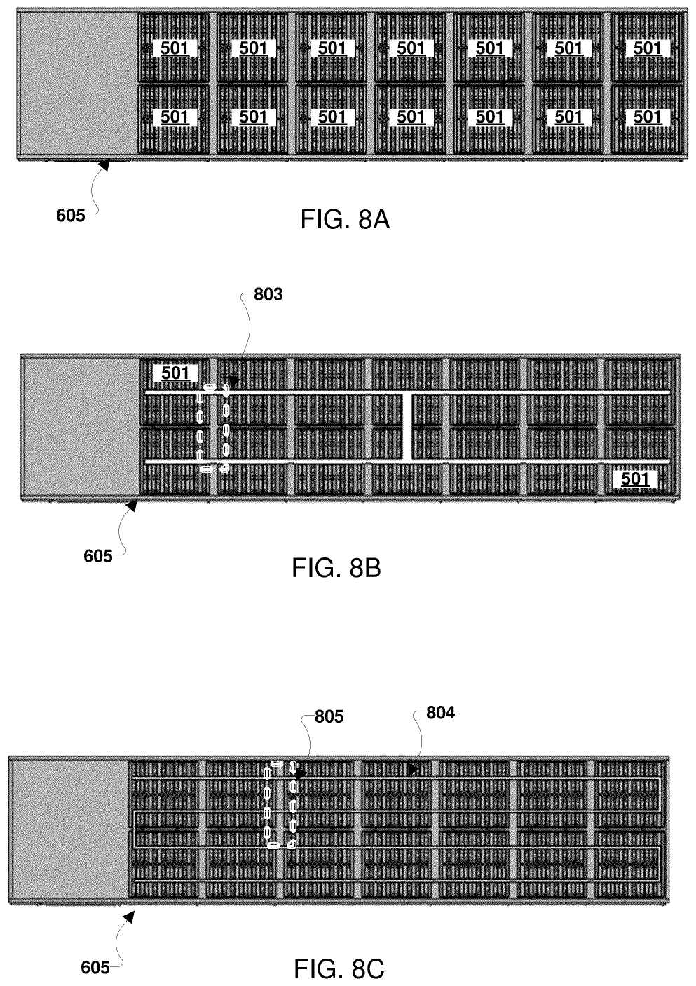

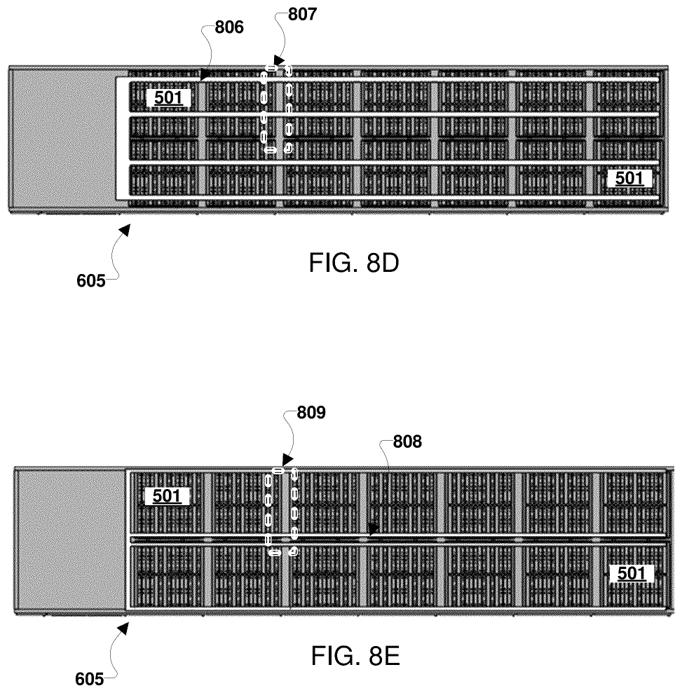

FIGS. 8A-8E are schematic representations of example layouts of a plurality of instances of the module 501 within the enclosure 605. In each of the layouts shown in FIGS. 8A-8E, two instances of the module 501 are arranged front to back within a given bay of the enclosure 605. In these layouts, electrical routing may be provided, and all hookups may be on the enclosure 605 short end. Further, space may be provided within the enclosure 605 to facilitate removal of an instance of the module 501. Further or instead, width of an electrode of electrochemical cells of the module 501 may be tied to the smallest dimension of the enclosure 605. Still further, or instead, thermal spacing of the electrochemical cells of the module 501 and/or of a plurality of instances of the module 501 relative to one another may be tied to the smallest dimension of the enclosure 605. Certain layouts may include connection and/or disconnection of a back portion of one or more instances of the module in each bay of the enclosure 605. Still further, or instead, the layout may facilitate some activities of personnel being performed within the enclosure 605.

Referring now to FIG. 8B, a thermal management ducting/plumbing system 803 may be within the enclosure 605 to facilitate installing and/or removing one or more instances of the module 501. Referring now to FIG. 8C, an electrical system connection configuration 804 and electrical connections 805 may be within the enclosure 605 to facilitate installing and/or removing one or more instances of the module 501. Referring now to FIG. 8D, GDE air system 806 and air connections 807 may be within the enclosure 605 to facilitate installing and/or removing one or more instances of the module 501. Referring now to FIG. 8E, a water and/or electrolyte system 808 and fluid connections 809 may be within the enclosure 605 to facilitate installing and/or removing one or more instances of the module 501.

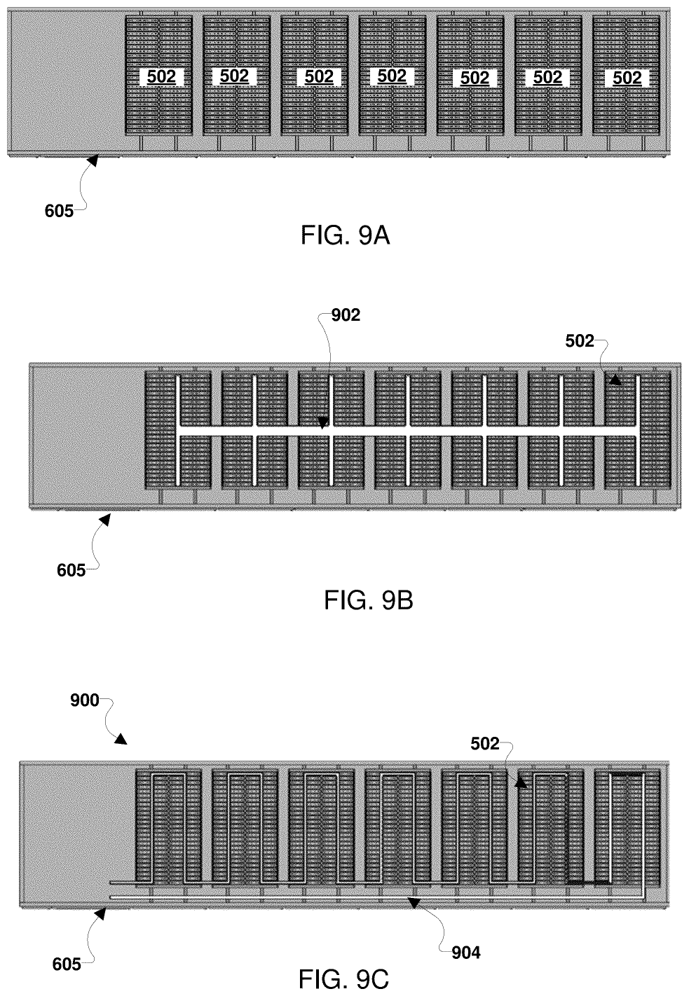

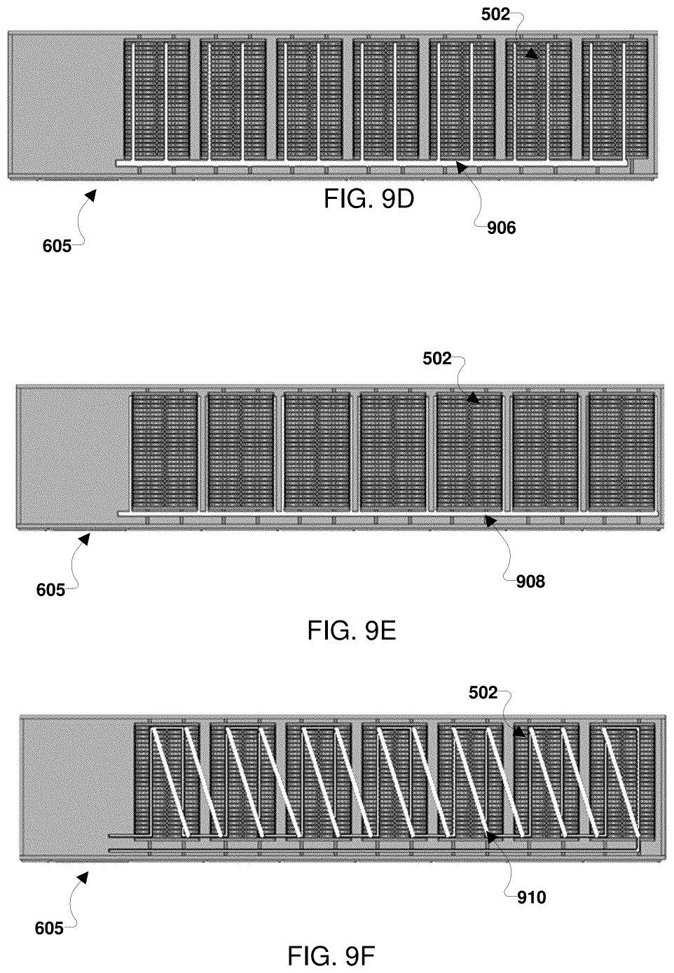

FIGS. 9A-9F ae schematic representations of example layouts of a plurality of instances of the module 502 within the enclosure 605. In each of these layouts, the module connections may be at the doors of the module 502. Referring now to FIG. 9B, a thermal management ducting/plumbing system configuration 902 may be within the enclosure 605. Referring now to FIG. 9C, an electrical system connection 904 may be within the enclosure 605. Referring now to FIG. 9D, a GDE air system connection 906 may be inside the enclosure 605. Referring now to FIG. 9E, a water and/or electrolyte system connection 908 may be within the enclosure 605. Referring now to FIG. 9F, a second electrical system connection 910 may be within the enclosure 605. The second electrical system connection 910 may including blind mating at the back of each instance of the module 502 and front side connections.

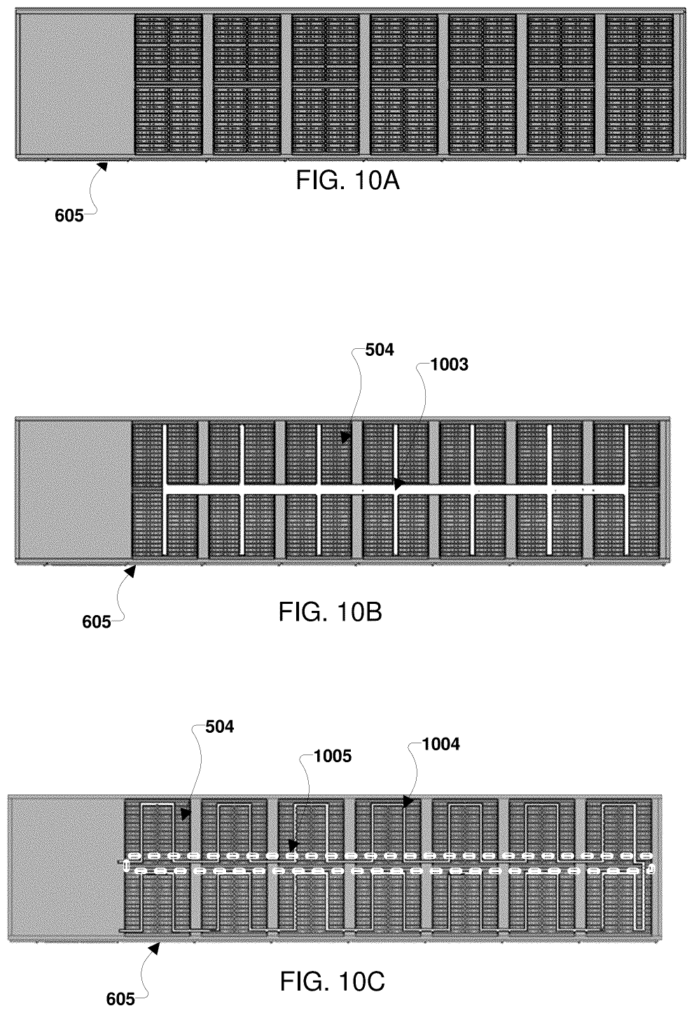

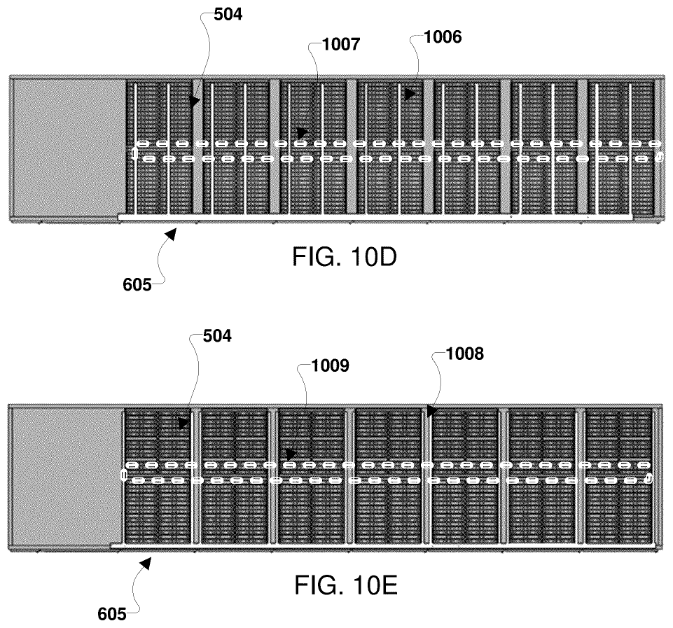

FIGS. 10A-10E are schematic representations of example layouts of a plurality of instances of the module 504 within the enclosure 605. In each of these layouts, two instances of the module 504 may be arranged front to back within a bay of the enclosure 605. In these layouts, space may be provided within the enclosure 605 to facilitate removal of an instance of the module 504. Further, or instead, in these layouts, electrode width of electrochemical cells in each instance of the module 504 may be independent of width of the enclosure 605. These layouts may include connection and/or disconnection of a back of one of the two instances of the module 504 in each bay. Still further, or instead, these layouts may facilitate some activities of personnel being performed in the enclosure 605.

Referring now to FIG. 10B, a thermal management ducting/plumbing system 1003 may be within the enclosure 605. Referring now to FIG. 10C, an electrical system 1004 and electrical connections 1005 may be within the enclosure 605 to facilitate installing and/or removing one or more instances of the module 504. Referring now to FIG. 10D, a GDE air system 1006 and air connections 1007 may be within the enclosure 605 to facilitate installing and/or removing one or more instances of the module 504. Referring now to FIG. 10E, a water and/or electrolyte system 1008 and fluid connections 1009 may be within the enclosure 605 to facilitate installing and/or removing one or more instances of the module 504.

While FIGS. 8A-10E represent various configurations for enclosures and modules within those enclosures, the layouts shown in FIGS. 8A-10E shall be understood to be examples according to various embodiments and are not intended to be limiting. Other layouts for enclosures and modules within those enclosures are additionally or alternatively possible.

Electrode to lid sealing (e.g., sealing between the GDE 404 to lid 455 in FIG. 4B) may present challenges. For example, alkaline electrolyte has a tendency to creep along a negatively polarized electrode. As another example, reaction within the electrochemical cell may result in electrolyte mist populating the cell headspace. Such electrochemically driven creepage and/or electrolyte mist may result in the electrolyte working its way out of the vessel of the electrochemical cell (e.g., out of the vessel 401 in FIGS. 4A and 4B) and contaminating the surrounding area. To reduce the likelihood of such inadvertent movement of the electrolyte out of an electrochemical cell, as may be critical to performance of the electrochemical cell, a hermetic seal may be formed between the lid and one or more subcomponents of the electrochemical cell, including an electrode busbar and/or plumbing attachments.

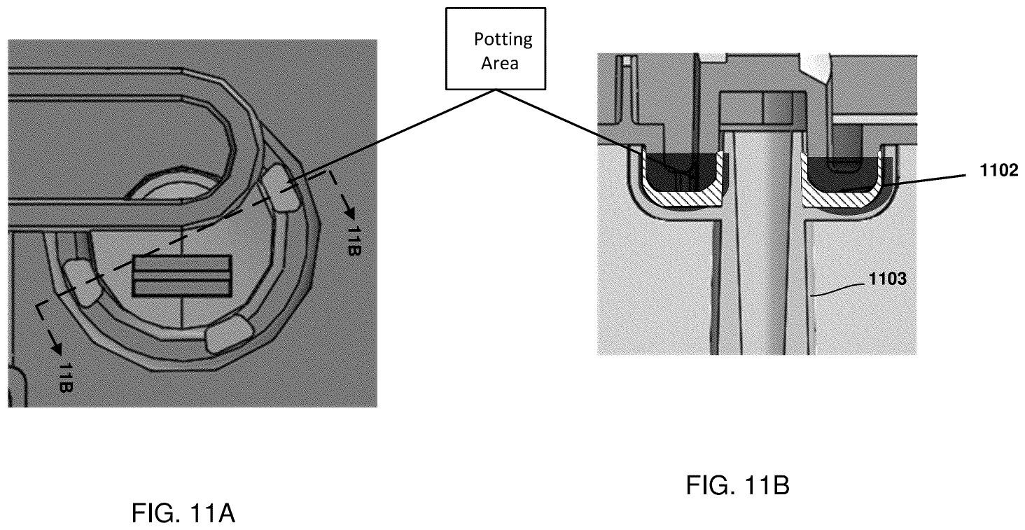

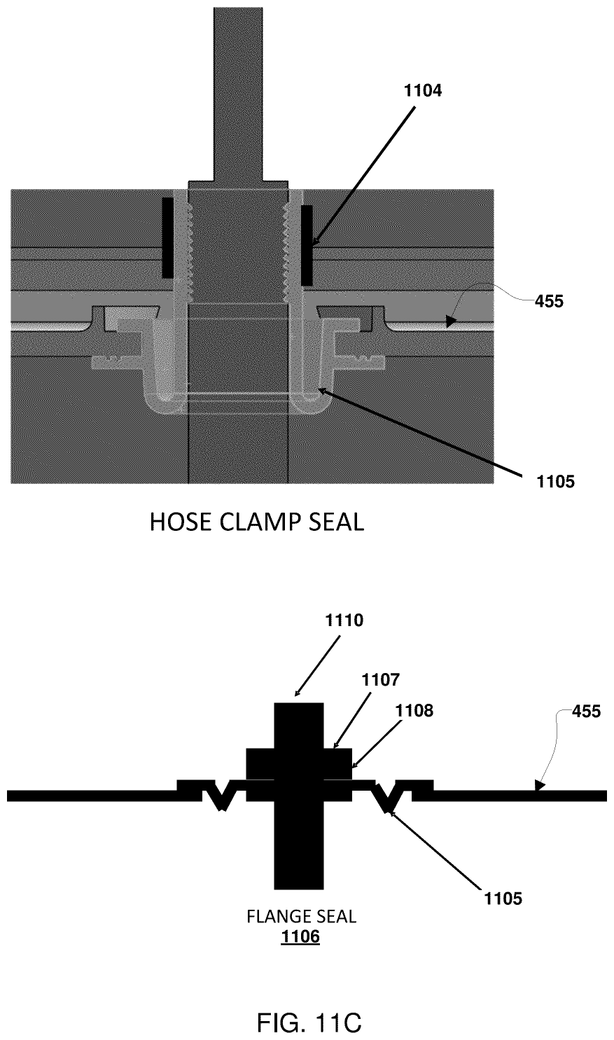

Referring now to FIGS. 1-11B, in various embodiments, passthrough portions of the lid 455 may be formed of dissimilar plastics. One approach to sealing the passthroughs may include a nested plastic cup in the respective plastic parts with epoxy 1102 therebetween to create a sealed passthrough through the lid 455 of the vessel 401. The approach shown in FIG. 11A may be a nesting trough design that provides a potting reservoir between the lid 455 and a cathode air tube 1103, with little or no need for a secondary dam to reduce the likelihood of leakage during the potting process. This feature also facilitates sealing while having access only to the top face of the lid—which provides flexibility in the order of operations of assembling the electrochemical cell 400. Holes in the lid 455 trough may provide access points for potting the epoxy 1102 into the lower trough. The epoxy 1102 may seal the lid 455 and the cathode air tube 1103 together with little or no risk of seeping into the cell area below.

FIG. 11C is a schematic representation of an implementation including a bellows feature to seal the lid 455. In some instances, a low durometer thermoplastic elastomer (TPE) may be overmolded to hard plastic of the lid 455 to provide positioning flexibility between subcomponents of the electrochemical cell and the lid 455. A bellows 1105 in the TPE may facilitate moving a busbar of the electrochemical cell freely with respect to the lid 455 with little or no transfer of mechanical loads through the bellows 1105. The TPE also, or instead, may act as a gasket material, facilitating mechanical sealing between the TPE and the busbar with a radial hose clamp seal 1104 and/or a flange seal 1106 including a nut 1107, washer 1108, and a threaded stud with shoulder 1110.

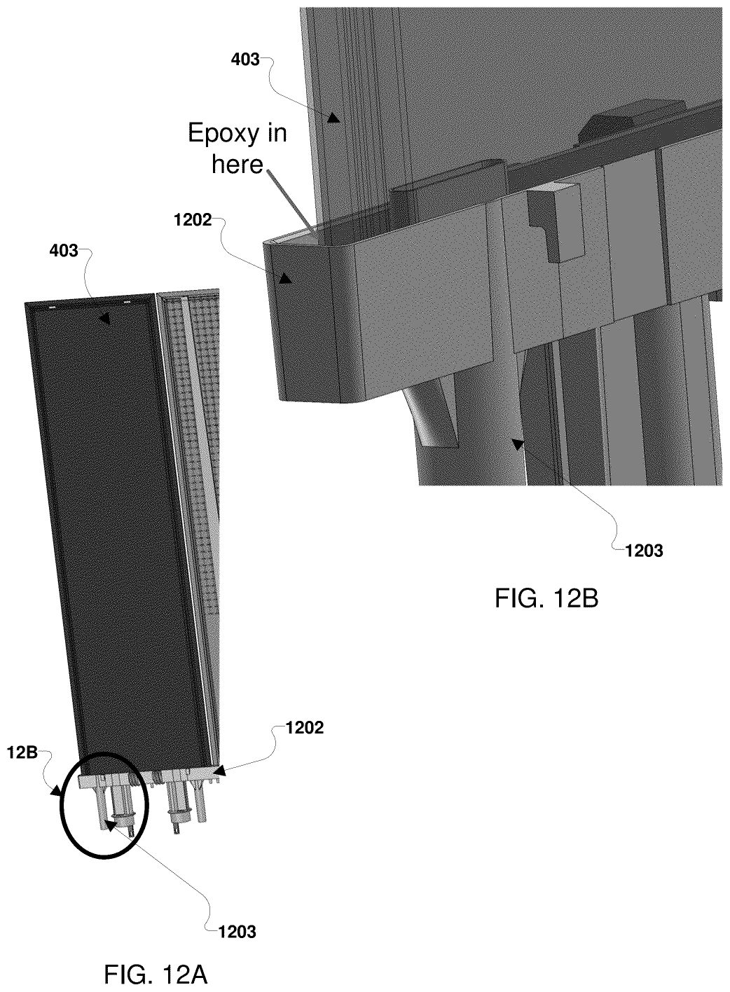

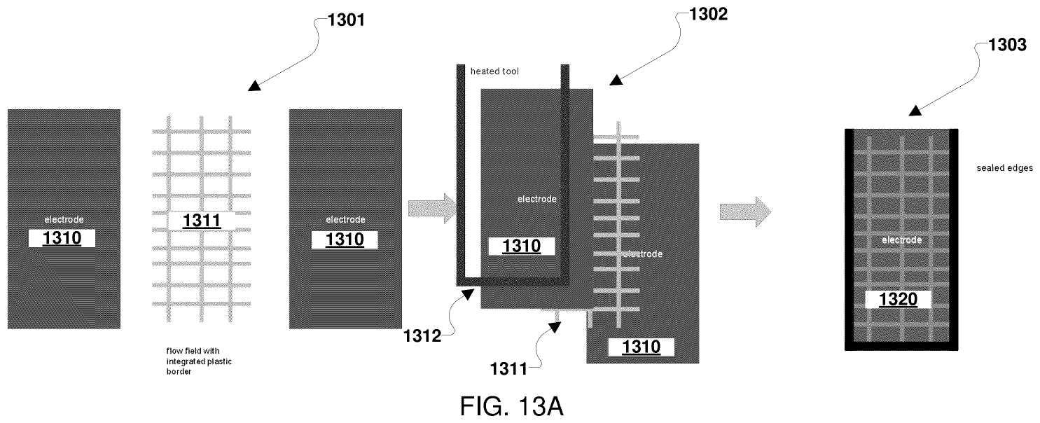

Referring now to FIGS. 12A and 12B, the GDE 404 may be sealed in some instances. For example, the GDE 404 may include a plastic containment piece 1202. The GDE 404 may be an electrode pocket with an open cavity area internal to the GDE 404 and into which air may be passed. During construction of the GDE 404, the GDE 404 may be inverted relative to its operational orientation and inverted epoxy sealing of the top edge of the GDE 404 may be performed to facilitate air passthrough to the active area of the GDE 404 after construction. The GDE 404 pocket may be sealed on the top and final edge by an epoxy potting process that occurs inverted to the operational mode of the GDE 404. The liquid level may fall high enough to wet the electrode area and seal it, and the plastic containment piece 1202 may define passages 1203 to direct air into and out of the GDE 404 that is otherwise sealed.

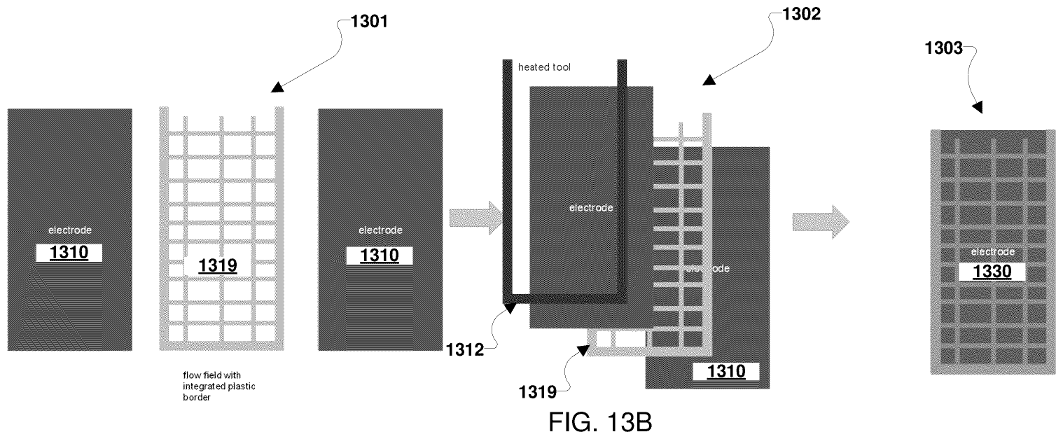

FIG. 13A is a schematic representation of an exemplary process for pressing a flow field 1311 in place during seal lamination of an electrode (e.g., the GDE 404 of FIG. 4B). For example, a flow field may be installed in a bifacial electrode assembly (e.g., the GDE 404 of FIG. 4B) as electrodes are sealed together. Positioning the flow field 1311 between two separate electrode sheets 1310, and applying heat and/or pressure to seal the edges around the flow field 1311 on three sides. Back layers of the electrodes may seal to themselves. For example, in a first step 1301, two separate electrode sheets 1310 may be provided along with a flow field 1311, and the flow field 1311 may be arranged between the two separate electrode sheets 1310. In a next step 1302, a heated tool 1312 may be pressed to the two separate electrode sheets 1310 aligned over one another such that the two separate electrode sheets 1310 are melted together at three sides to form sealed edges and for a bifacial electrode assembly 1320 (e.g., the GDE 404) at step 1303.

FIG. 13B is a schematic representation of another exemplary process for pressing an air flowfield in place during seal lamination of an electrode (e.g., the GDE 404 of FIG. 4B). The exemplary process of FIG. 13B is similar to the exemplary process shown in FIG. 13A, except the exemplary process shown in FIG. 13B includes using a flow field 1319 with an integrated boarder that overlaps the seal between the two separate electrode sheets 1310. According to this approach, heat and/or pressure may be applied by the tool 1312 to seal the edges around the flow field 1319, and a plastic border of the flow field 1319 may act the sealing medium to form a bifacial electrode assembly 1330.

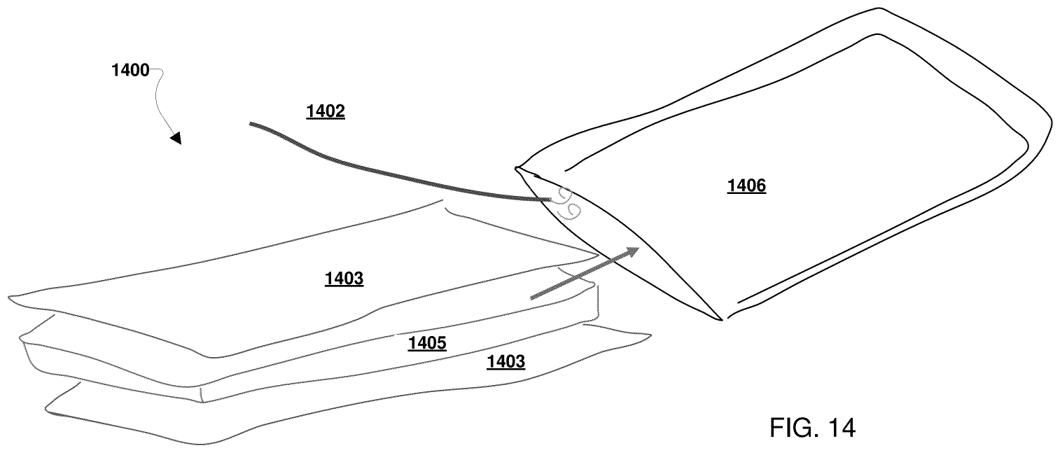

FIG. 14 is a schematic representation of an exemplary method 1400 for inserting a flow field 1405 into a pre-sealed electrode assembly 1406 to form an electrode (e.g., the GDE 404 of FIG. 4B). For example, a pre-sealed electrode assembly 1406 with three seams sealed to form a pocket may have a flow field 1405 installed according to the exemplary method 1400 by placing slip sheets 1403 of low surface energy plastic on either side of the flow field 1405. Compressed air from an air line 1402 may be blown into the pre-sealed electrode assembly 1406 such that the pocket formed by the pre-sealed electrode assembly 1406 may expand and the slip sheets 1403 and the flow field 1405 may be inserted into the pocket of the pre-sealed electrode assembly 1406. The slip sheets 1403 may be removed after installation such that only the flow field 1405 is left in place in the pocket defined by the pre-sealed electrode assembly 1406.

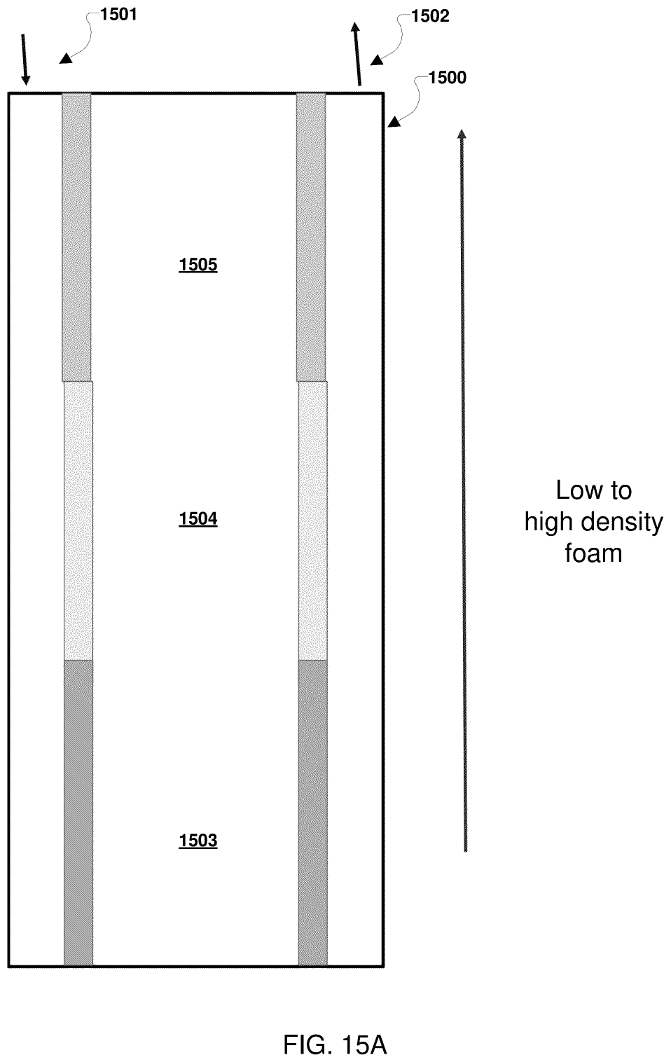

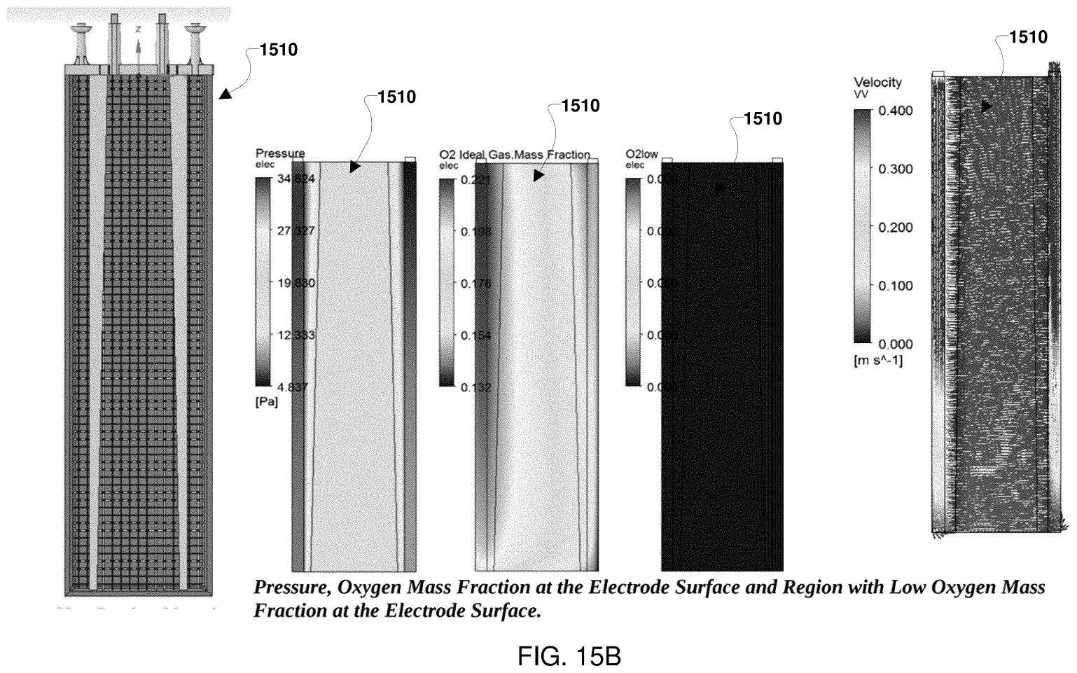

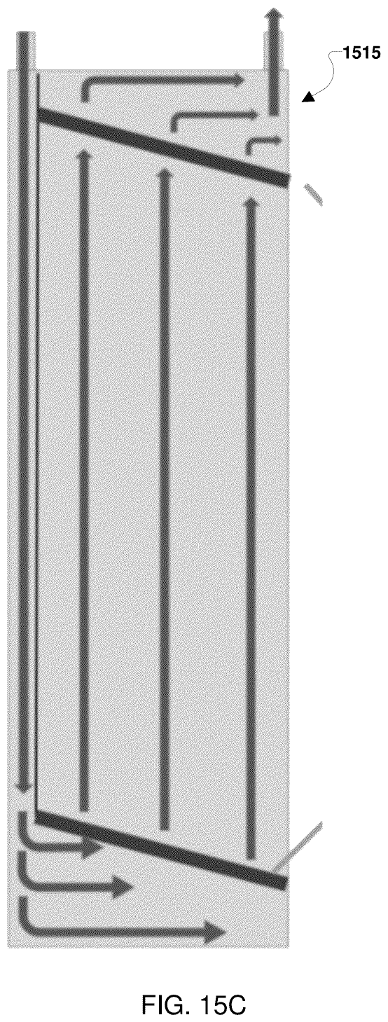

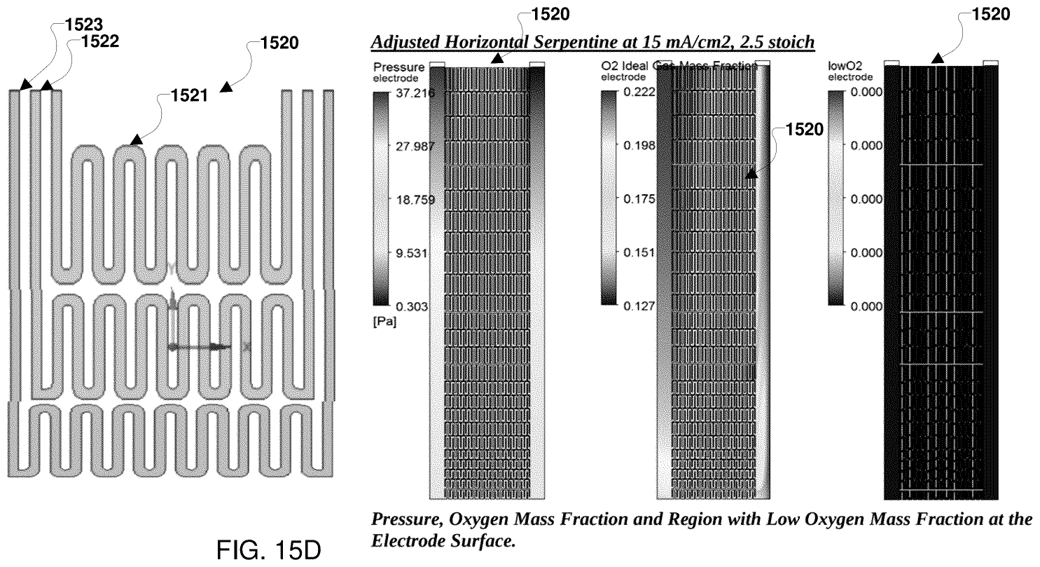

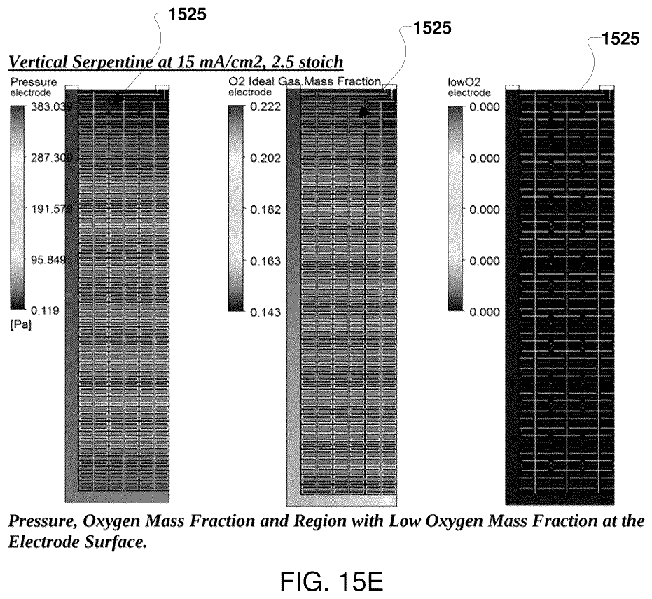

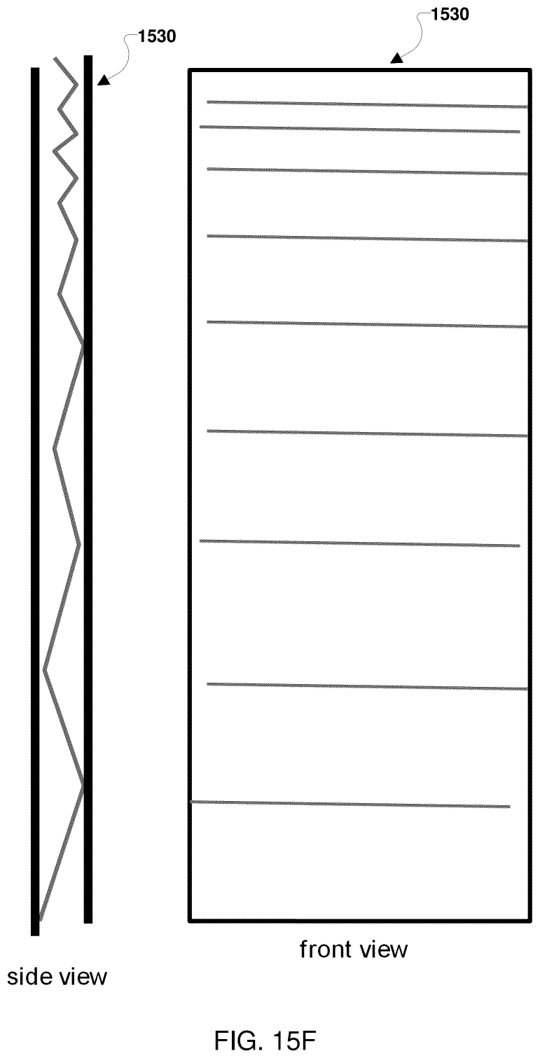

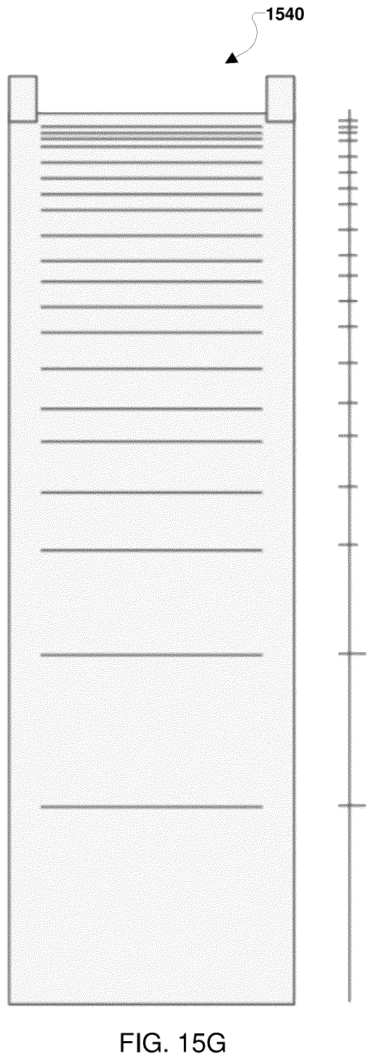

Referring now to FIG. 15A, the flow field 1500 may include porous media such that an electrode (e.g., the GDE 404 of FIG. 4B) may be formed with a low pressure, high uniformity flow between two electrode plates (e.g., between the first portion 404a of the GDE 404 and the second portion 404b of the GDE 404 of FIG. 4C and/or between the first portion 404a′ and the second portion 404b′ of the GDE 404′ of FIG. 4D). In the flow field 1500, air may be substantially uniformly distributed across a long and narrow active area of the electrode, using symmetrical stacks of open cell foam 1503, 1504, 1505 of varying porosities to facilitate controlling pressure drop across the surface. For example, the open cell foam 1503 may have lower density than the open cell foam 1504, and the open cell foam 1505 may have a higher density than each of the open cell foam 1503 and the open cell foam 1504. Air may enter the flow field 1500 at an inlet opening 1501 and exit the flow field 1500 from an outlet opening 1502 after passing through the open cell foam 1503, the open cell foam 1504, and/or the open cell foam 1505. The flow field 1500 may also, or instead, mechanically and/or electrically isolates the two faces of the electrode from one another, providing a mechanical cavity for air to access the electrode. In instances in which the flow field 1500 is formed of foam, the flow field 1500 may include pins therein to keep the two faces of the electrode from touching one another.

FIG. 15B shows computational fluid dynamic/finite element analysis simulation results of a flow field 1510 in which air is uniformly distributed across a long, narrow active area of an electrode (e.g., the GDE 404 of FIG. 4C and/or the GDE 404′ of FIG. 4D) using two symmetrical opposing strips of filter felt with a tapered geometry to balance pressure drop across the inlet to the outlet of the electrode.

FIG. 15C is a schematic representation of a flow field 1515. Generally, the flow field 1515 is similar to the flow field 1510 (FIG. 15B), except the flow field 1515 uses a vertical feed and laterally positioned porous media strips to control and distribute air flow.

FIG. 15D shows computational fluid dynamic/finite element analysis simulation results of a flow field 1520 having a low pressure and high uniformity and formed using horizontal serpentine channels 1521, 1522, 1523 of varying heights. The flow field 1520 may substantially uniformly distribute air across a long and narrow active area of an electrode (e.g., such as between the first portion 404a of the GDE 404 and the second portion 404b of the GDE 404 in FIG. 4C and/or between the first portion 404a′ and the second portion 404b′ of the GDE 404′ in FIG. 4D) using the horizontal serpentine channels 1521, 1522, 1523, which may be symmetrically stacked and have decreasing height from top to bottom to achieve a uniform path length from inlet to outlet across the entire surface. The flow field 1520 may also, or instead, be resistant to flooding in that an electrolyte in the bottom of the flow field 1520 may not choke flow to the entire electrode.

FIG. 15E shows computational fluid dynamics/finite element analysis simulation results of a flow field 1525 including vertical serpentine channels fed by a vertical inlet running from the top of the flow field 1525 to the bottom of the flow field 1525. Air may be fed down to the bottom of the flow field 1525 and dispersed across the vertical serpentine channels across the main portion of the active area up to the outlet.

FIG. 15F is a schematic representation a long, narrow active area of an electrode including accordion folds of increasing height from top to bottom to form a flow field 1530. Smaller, more restrictive channels are created by bends toward the top of the active area, whereas more open flow occurs at the bottom of the flow field 1530.

FIG. 15G is a schematic representation of a long, narrow active area of an electrode including a ladder structure having increasing spacing from the top to the bottom of the electrode to form a flow field 1540.

Using less inactive material in each electrochemical cell helps decrease the system cost without losing any performance. A vessel for an electrochemical cell serves the dual purpose of isolating instances of electrochemical cells from one another, and providing the structure to hold cell shape of each instance of the electrochemical cell. The amount of material needed to fulfill this functionality can result in large costs associated with inactive material. By moving the structural functionality from the level of individual instances of the electrochemical cell to the level of the module, the sole purpose of the vessel may become providing electrical insulation. This can be achieved, for example, by using thin plastic bags to house each electrochemical cell, with structural end walls to sandwich the bags together. This decreases the amount of material needed, thereby decreasing overall cost.

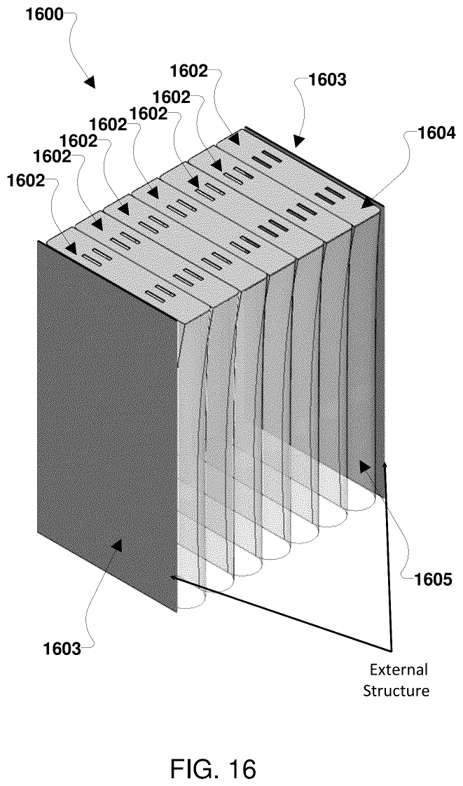

FIG. 16 is a perspective view of a module 1600 including a plurality of instances of an electrochemical cell 1602 separated by bags 1605 and in which structural support is provided at the level of the module 1600. Structural end walls 1603 may support the plurality of instances of the electrochemical cell 1602 therebetween. Each instance of the electrochemical cell 1602 may include a lid 1604 that may support one or more of the bags 1605. The lid 1604 of each instance of the electrochemical cell 1062 may connect together to other instances of the lid 1604 and/or to the structural end walls 1603 to form the module 1600 of the plurality of instances of the electrochemical cell 1602 connected to one another.

In various embodiments, the electrodes (e.g., the first anode assembly 402a, the second anode assembly 402b, the first OEE 403a, the second OEE 403b, and the GDE 404 of FIG. 4B) in the vessel may be closely packaged. The cathodes (e.g., the first OEE 403a, the second OEE 403b, and the GDE 404 of FIG. 4B) may be switched to cycle against the anode (e.g., the first anode assembly 402a and the second anode assembly 402b) based on the charge or discharge cycle of the electrochemical cell but do not cycle at the same time. Electrical isolation of the cathode from the anodes is required to prevent unintentional shorting. Additives to the electrochemical cell may improve performance of one electrode but may be detrimental to another electrode. Methods of containing additives to a localized zone around an electrode or reducing the likelihood or even preventing additives from permeating to other zones of the electrochemical cell may be beneficial to performance of the electrochemical cell.

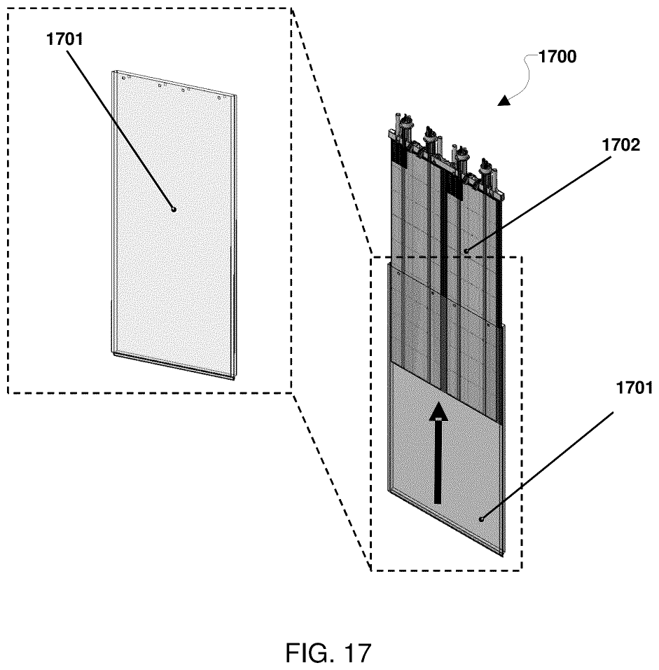

FIG. 17 is a schematic representation of a cathode 1700 including a separator 1701 and a cathode subassembly 1702 (e.g., the first OEE 403a and/or the second OEE 403b in FIG. 4B). As an example, the separator 1701 may include separator material in the form of sheets and/or a bag. As a specific example, the separator 1701 may be formed by folding one large sheet of separator material and sealing the edges or taking two individual sheets of separator material and sealing them together along three edges. Thus, the separator 1701 may be open at the top. The cathode subassembly 1702 may be inserted into the of the separator 1701. The separator 1701 may be ionically conductive, allowing ions to pass through freely, but electrically insulative to prevent electrical shorting between electrodes. Further, or instead, the material of the separator 1701 may allow ions to pass while not allowing electrolyte additive species to pass. Further, or instead, the separator 1701 may be impermeable to bubbles generated by the cathode subassembly 1702 such that the bubbles do reach the anode (e.g., the first anode assembly 402a and/or the second anode assembly 402b in FIG. 4B). Likewise, the material of the separator 1701 may be impermeable to bubbles from the anode such that these bubbles do not reach the cathode subassembly 1702. The sealed bottom of the separator 1701 may also reduce the likelihood of, or even prevent, electrical shorting due to particulates that may accumulate at the bottom of the electrochemical cell between the electrodes. In another embodiment, the bottom of the separator 1701 may be open instead of sealed, resulting in a sleeve-like design.

Electrodes in the vessel of an electrochemical cell may require electrical isolation from each other. Each electrode operates at a different potential. Some electrodes cannot operate at the same potential as others in the system. If an electrode A is not compatible with the potential of electrode B, shorting of the two electrodes may result in degradation of either electrode. During cycling, some electrodes produce bubbles which can coalesce and cause blocking between the electrodes. Blocking between electrodes can increase ohmic resistance, cause mass transport issues, dry out an electrode resulting in loss of performance, locally deteriorate the surface of an electrode, and/or have other negative effects to the cell. Additionally, or alternatively, certain electrode operating potentials may lead to the degradation of plastics used as separator materials and can lead to shorting.

Various embodiments may include a standoff and separator to reduce the likelihood of shorting between the charge electrodes (e.g., the first anode assembly 402a and the second anode assembly 402b and either one of the first OEE 403a and the second OEE 403b).

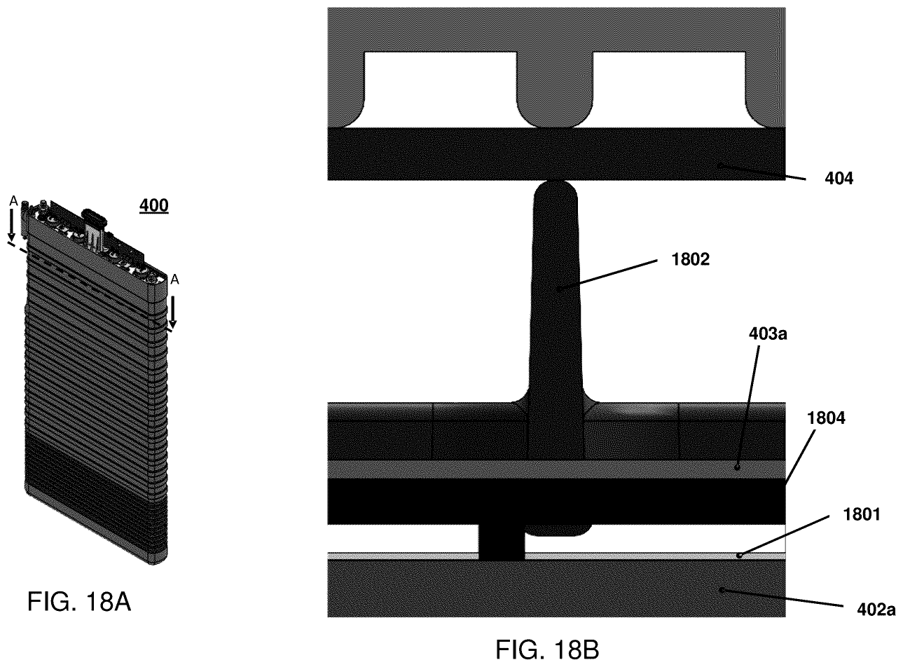

Referring now to FIGS. 18A and 18B, the electrochemical cell 400 may include a separator 1801, a first standoff 1802, and a second standoff 1803. The first standoff 1802 may be disposed between the OEE and the anode, and the second standoff 1804 may be disposed between the GDE 404 and the first OEE 403a. The separator 1801 and the second standoff 1803 may be disposed between the first OEE 403a and the first anode assembly 402a. The separator 1801 reduces the likelihood of shorting between the first anode assembly 402a and the first OEE 403a. The second standoff 1803 may provide space for oxygen bubbles generated during charge to egress vertically from the active surface. The material of the second standoff 1803 may be compatible with the potential of the first OEE 403a. The second standoff 1803 between the separator 1801 and the first OEE 403a may eliminate, or at least reduce, material compatibility concerns with the separator 1801 and the first OEE 403a. The first anode assembly 402a and the first OEE 403a are shown, but it shall be understood that analogous standoffs and separators may be additionally or alternatively be disposed between the GDE 404 and the second OEE 403b and between the second OEE 403b and the second anode assembly 402b. For the sake of clear illustration and efficient description, these are not described separately.

In certain implementations, the separator 1801 may be a sheet of separator material. For example, the material of the separator 1801 may be ionically conductive, allowing ions to pass through freely, but electrically insulative to prevent electrical shorting between electrodes. Further, or instead, the material of the separator 1801 may allow ions to pass while not allowing electrolyte additive species to pass. Further, or instead, the separator 1801 may be impermeable to bubbles generated by the first OEE 403a and/or the GDE 404 such that the bubbles do reach the first anode assembly 402a. Likewise, the material of the separator 1801 may be impermeable to bubbles from the first anode assembly 402a such that these bubbles do not reach the first OEE 403a and/or the GDE 404. Further, or instead, while the separator 1801 is shown disposed on the first anode assembly 402a, it shall be appreciated that the separator 1801 may be supported on the first OEE 403a and/or on one or more structural components of the electrochemical cell 400. Further, or instead, the separator 1801 may disposed between the GDE 404 and the first OEE 403a. Still further, or instead, it shall be understood that there may be more than one instance of the separator 1801 disposed within the electrochemical cell 400, as may be useful for limiting movement of bubbles and/or electrolyte additive species within the electrochemical cell 400 while allowing ions to move within the electrochemical cell 400.

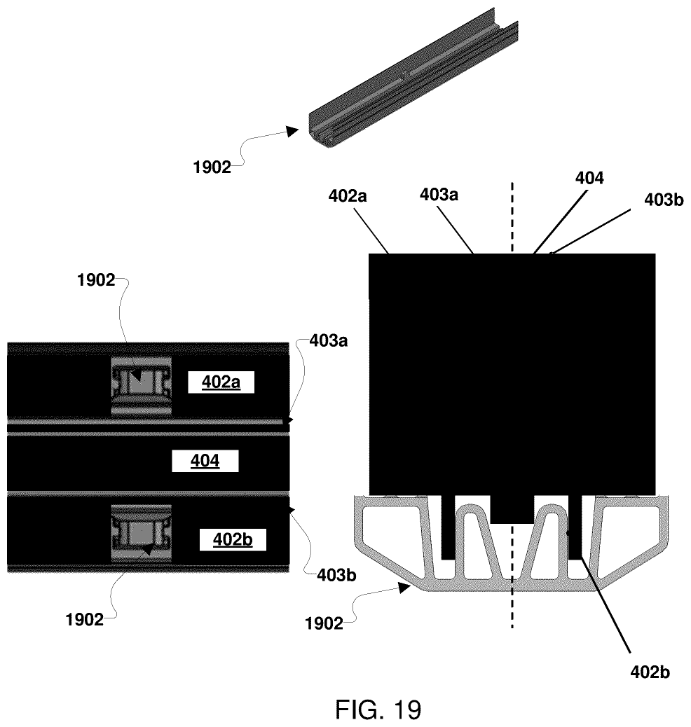

Referring now to FIG. 19, electrodes may be positioned in a vessel of an electrochemical cell in a manner that supports cell performance. For example, an electrode holder 19 may support portions of one or more electrodes (e.g., the GDE 404, the first anode assembly 402a, the first OEE 403a, the second anode assembly 402b, and the second OEE 403b in the vessel 401 of FIG. 4B). The electrode holder 19 may be, for example, extruded. Further, or instead, the electrode holder 1902 may datum the positions of the first anode assembly 402a and of the second anode assembly 402b at the bottom of the electrochemical cell. Walls at the bottom of the electrode holder 1902 may limit the distance the first anode assembly 402a and the second anode assembly 402b may translate towards the cathode stack to set the electrode spacing and reduce the likelihood of crushing the cathodes—the GDE 404, the first OEE 403a, and the second OEE 403b.

In some embodiments, a metal-air battery, such as an iron-air battery, may be constructed without the use of a separator, and electrodes in the metal-air battery may be separated to prevent shorts. In some embodiments, physical design of the electrochemical cell may provide required electrode gaps without the use of specific separator materials between electrodes. Especially in iron-air batteries where the electrode gap required may be millimeters in distance, separator-less configurations may be advantageous.

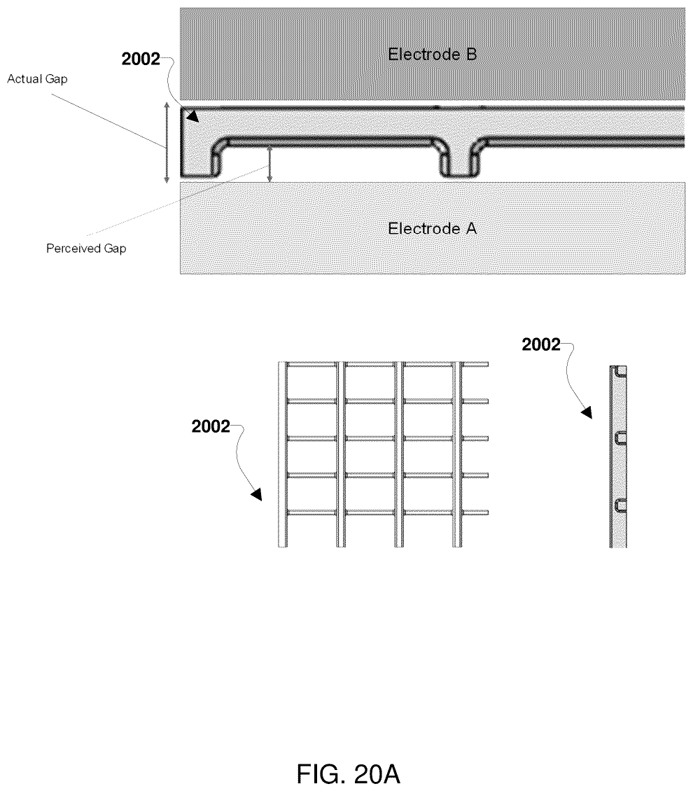

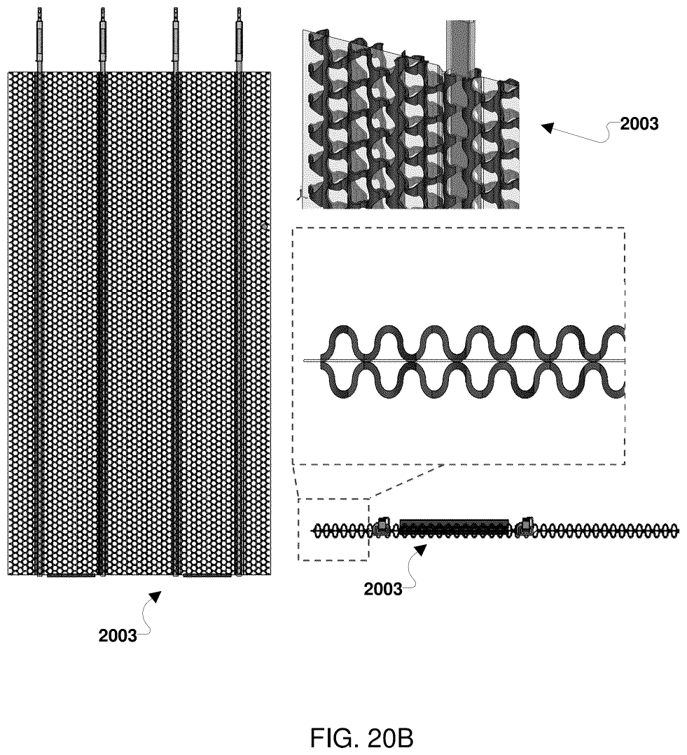

Referring now to FIG. 20A, a mesh standoff 2002 may be disposed between two electrodes—which are shown as electrode A and electrode B and shall be understood to include any two electrodes described herein. The gaps between the electrodes function to prevent electrical shorting. The gap also defines the minimum length that must be closed to cause a short. Using the mesh standoff 2002 between electrode A and electrode B defines the gap between the active faces. The vertical members of the mesh standoff 2002 may be larger than the horizontal members of the mesh standoff 2002. This allows for the gap between the electrode A and the electrode B to be larger than the perceived gap that an item would need to bridge to short the electrodes.

Referring now to FIG. 20B, a corrugated standoff 2003 may be used to separate two electrodes (e.g., any two electrodes described herein). The holes and spacing of the corrugations of the corrugated standoff 2003 may make a tortuous path for a shorting body while the planar view has a high open area to reduce the likelihood of occlusion between electrodes.

Referring now to FIGS. 20A and 20B, standoffs may aid in bubble management. During operation bubbles are generated within the electrochemical cell. These bubbles are products of cycling but can negatively impact performance of the electrochemical cell. For example, bubbles can coalesce and cause blockages in the cell, dry out the electrodes leading to degradation, and potentially cause surface damage to specific anodes. Standoffs, used for electrical isolation, may facilitate managing the bubbles. For example, the corrugated standoff 2003 may provide vertical channels for bubbles to egress out of the electrochemical cell. As another example, the horizontal members of the mesh standoff 2002 may be sub-flush from the vertical members to define channels for bubbles to egress out of the electrochemical cell.

Current generated from the electrode must be carried out of the electrochemical cell while limiting ohmic losses, minimizing non-uniformity of current distribution, and optimized for cost. Various embodiments may include electrode current collection.

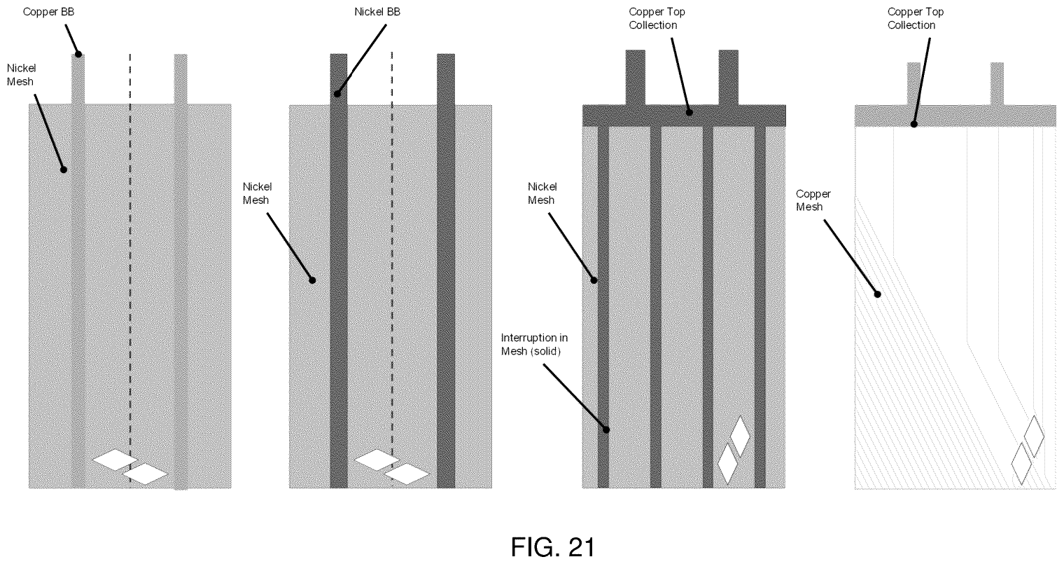

Referring now to FIG. 21, several methods may be used to reduce the ohmic drop along the electrode height and improve current uniformity in plane of the electrode. These methods may include: interrupting the expansion process to solid conductive sections in the active field of the electrode; interrupting the expansion process to produce solid sections and forming the solid sections (such as hemming) to produce 3D busbars in the mesh; post expansion addition of busbars in the active field of the electrode; post joining of cladded wire to the expanded mesh; and various combinations of the above. Additionally, methods were identified to reduce the ohmic drop along the electrode height and improve current uniformity in plane of the electrode may include orienting and sizing of an expanded mesh to minimize ohmic drop.

Concentration gradients may form as current is aggregated along the length of an electrode. These concentration gradients negatively impact efficiency of the electrochemical cell.

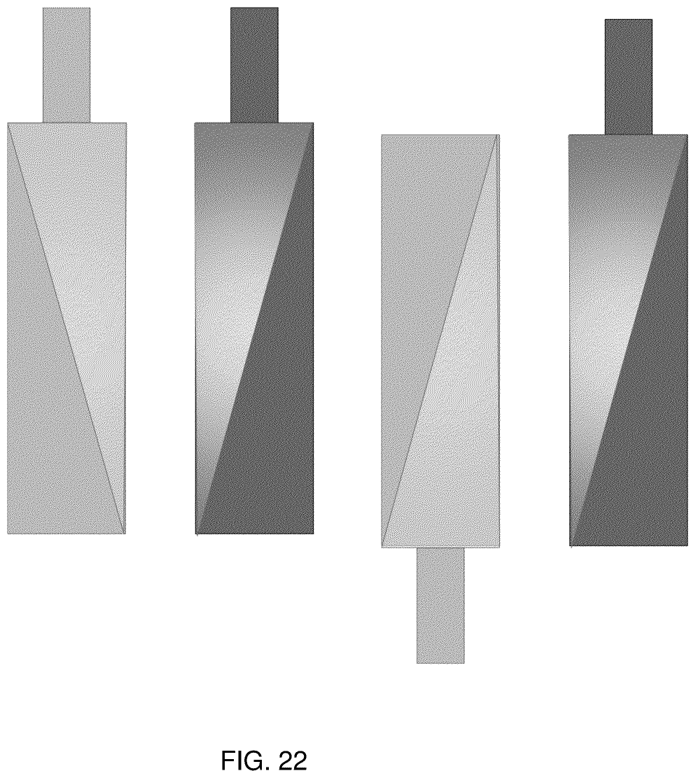

Referring now to FIG. 22, various embodiments may include anode current collection methods. To counteract concentration gradients due to current collection at the top of the electrode, collecting current at the bottom of one electrode and the top of the opposing electrode inverses the concentration gradients of adjacent electrodes relative to each other. This may allow for better utilization of each electrode and reduce inefficiency attributable to matching concentration gradients.

Various embodiments may include distributed electrode switching architectures. Large battery formats with a single switch to operate the battery may have to bus current over long distances. This may incur high losses, which decrease efficiency and increase heat generation in the system.

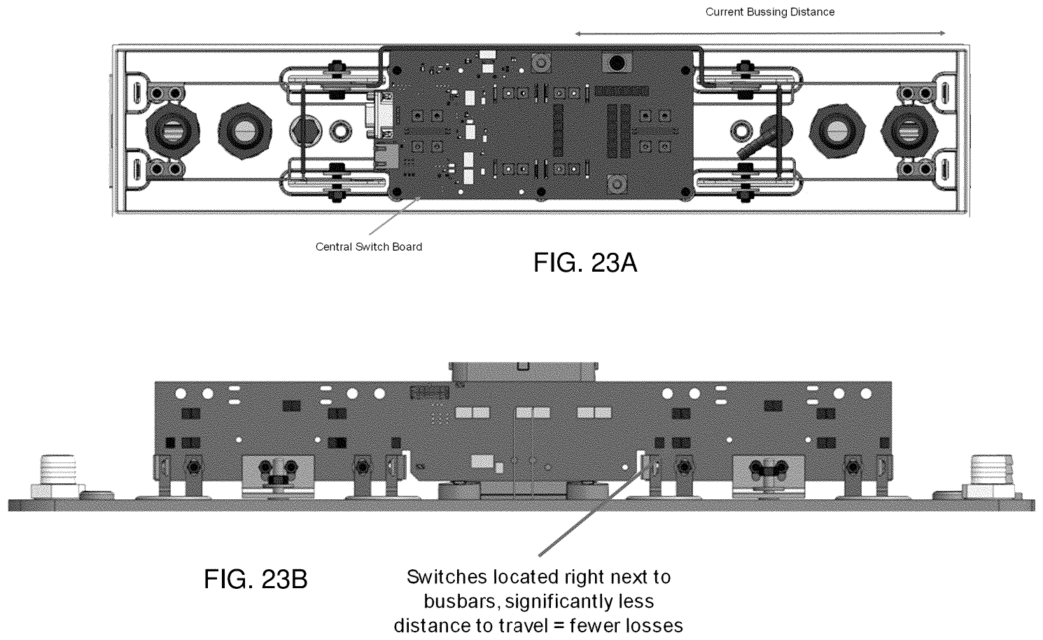

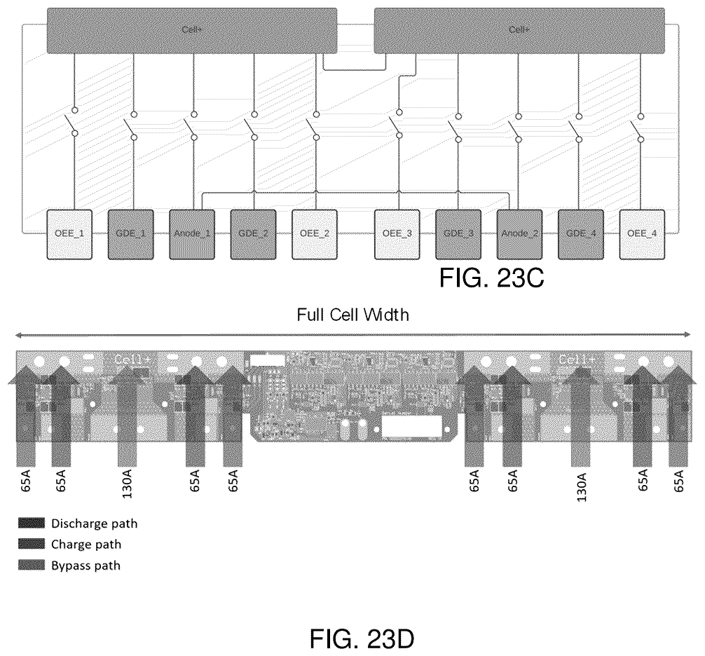

Referring now to FIGS. 23A-D, aspects of electrode switching control devices may support distributed electrode switching. Rather than a single centralized switch on a small printed circuit board (PCB) as shown in FIG. 23A, multiple switches in parallel may be distributed across the width of the electrochemical cell on a larger PCB as shown in FIGS. 23B-23D. In this example, there are four separate switch “islands” for the GDE and OEE, and two “islands” for the anode. The parallel connections may be made through the PCB (e.g., the electronics structure 450 in FIG. 4B). This may significantly decrease the losses due to bussing current. In one configuration, groups of switch elements may be mounted to a single large PCB. Alternatively, several smaller, independent PCBs may be connected to one another. The switching may be done with solid-state switch elements (MOSFETs), but it may also, or instead, be done with mechanical or electromechanical relays. In the variation with relays, all relays may be connected via a single mechanical linkage system. This may reduce or eliminate the need for a cell-level PCB entirely.

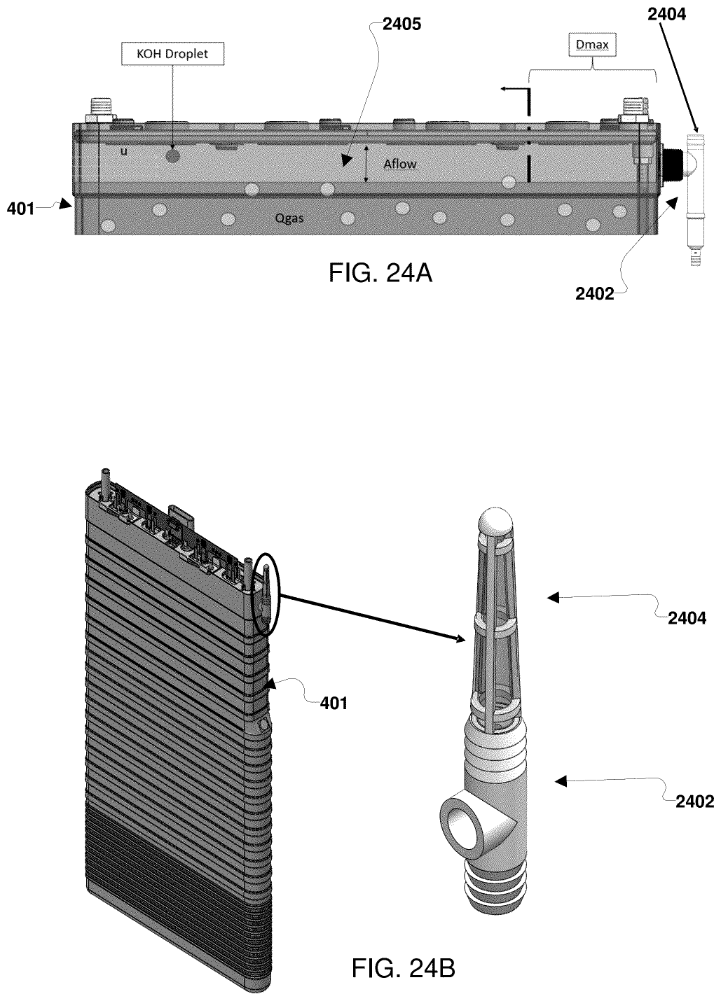

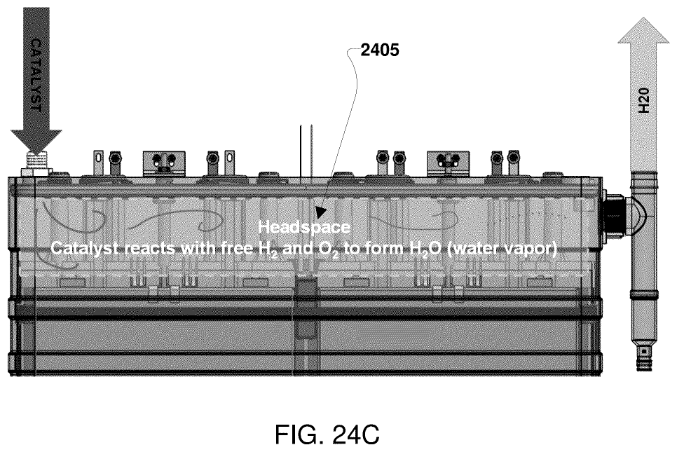

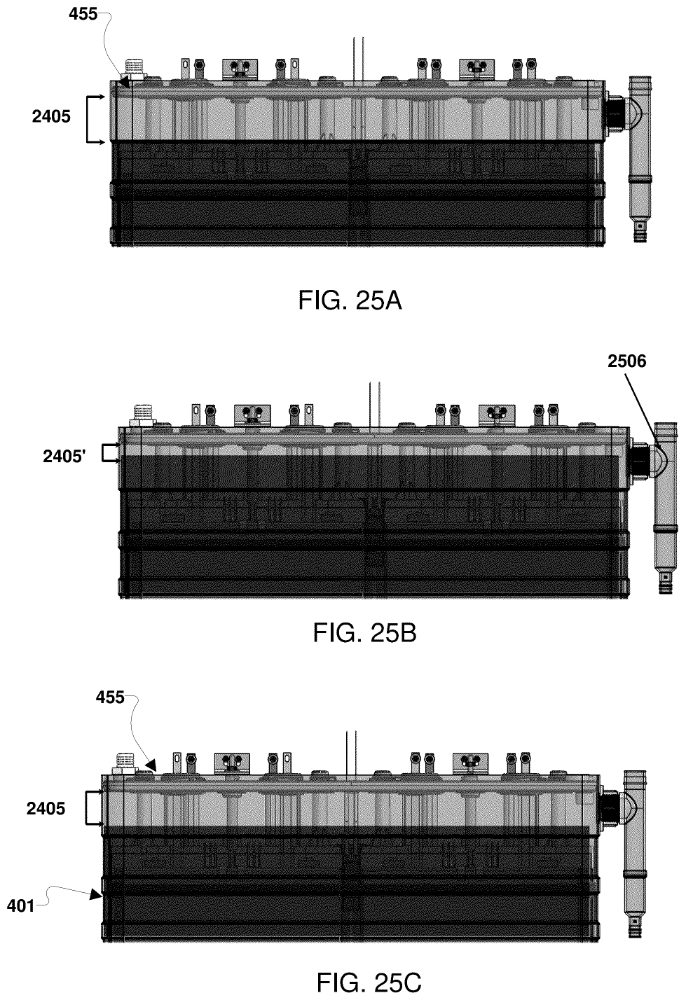

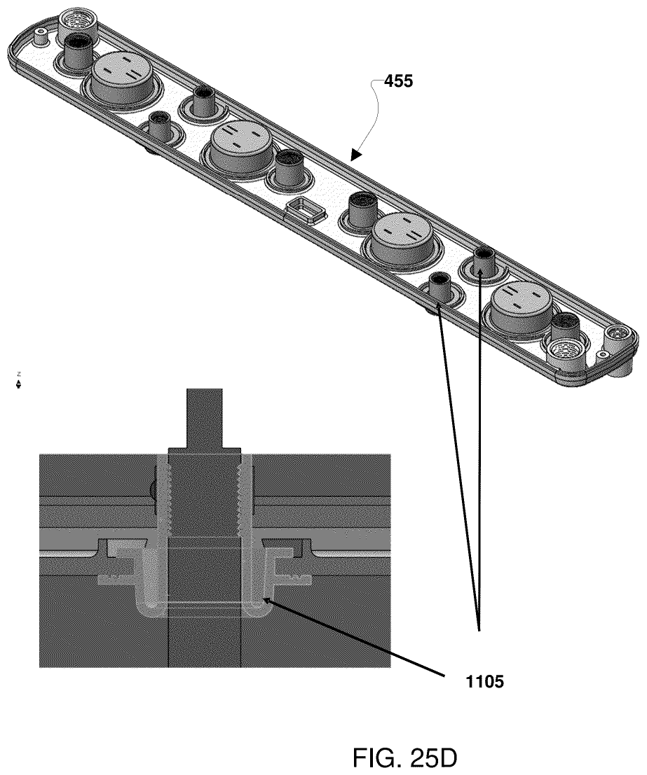

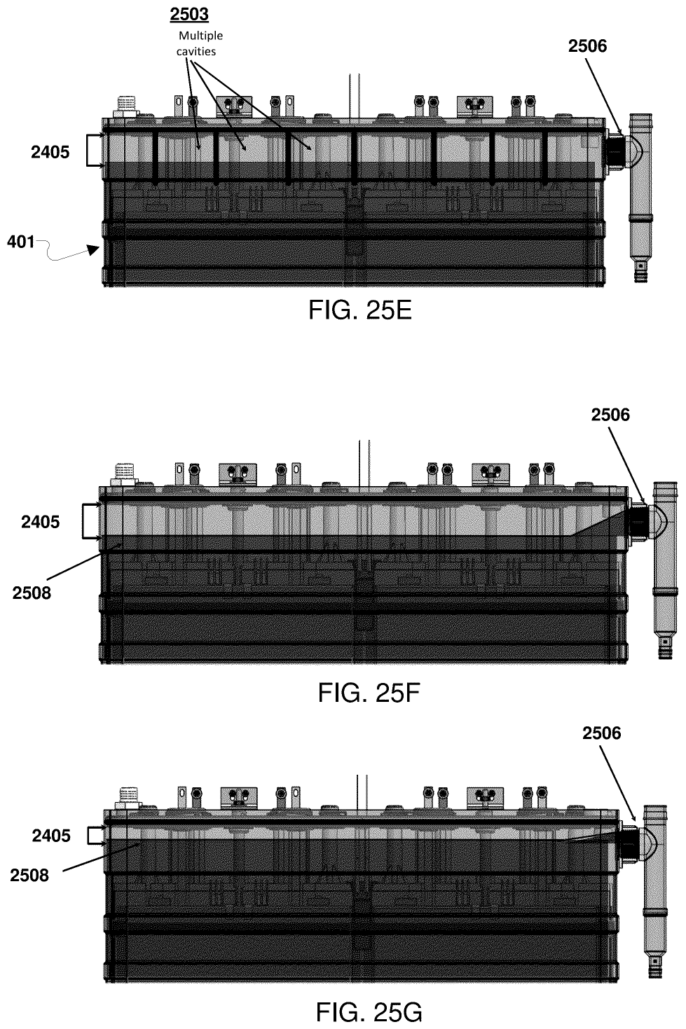

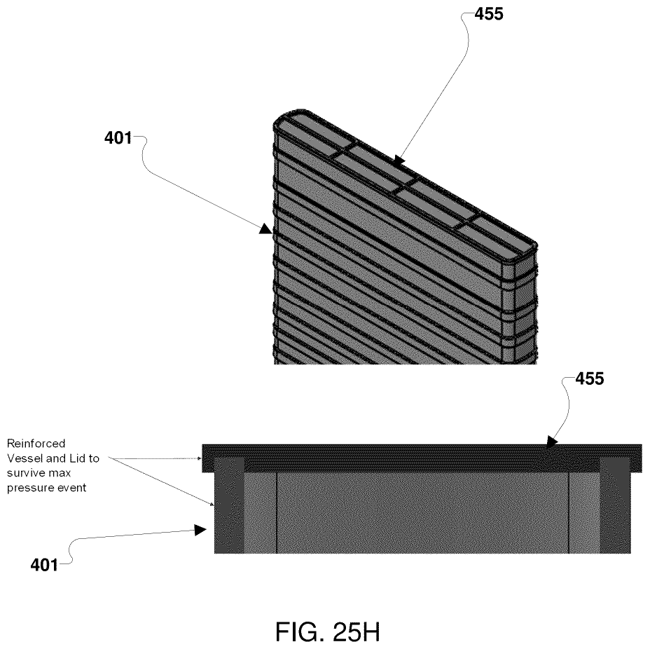

FIGS. 24A-25H are schematic representations aspects of cell demisting, flame arresting, and hydrogen management in accordance with various embodiments.

FIGS. 24A and 24B show schematic representations of a top portion of a vessel of an electrochemical cell (e.g., the electrochemical cell 400 in FIG. 4A) and a filter attachment to a vent. FIG. 24C is a schematic representation a method for recombination of hydrogen and oxygen into water in a headspace 2405 of a vessel of an electrochemical cell (e.g., the electrochemical cell 400 in FIG. 4A).

Referring now to FIGS. 24A-24C, the vent on the side of the vessel 401 may include a flame arrestor 2402 that may serve any one or more of several functions, including suffocating any ignited flame to reduce the likelihood of a cascading explosion, de-entrainment of electrolyte mist to keep electrolyte within the volume of the vessel 401, and straining any salting or debris that may form in the electrochemical cell during operation. The location of the flame arrestor 2402 on the side of the vessel 401 may make it more difficult for mist to escape the cell making the efficacy of a demister less critical. That is, the flame arrestor 2402 may additionally, or alternatively, serve the function of mist de-entrainment. The velocity “u” shown in FIG. 24A is from gas generation in the electrochemical cell. When gas is generated on charge, bubbles burst at the electrolyte surface creating a mist that carries electrolyte liquid. To mitigate electrolyte level loss associated with such mist, a filter 2404 may be supported on the flame arrestor 2402 to facilitate separating liquid from gas to retain electrolyte within the electrochemical cell. In this configuration, the velocity, “u” shall be understood to be associated with drawing air across the headspace 2405 to carry gas generated in the electrolyte volume out of the electrochemical cell via forced convection. To remove explosive gasses generated in the electrochemical cell, a catalyst may be supplied to the headspace 2405 to combine an explosive H2/O2 mixture into water. This may facilitate using only a vent on the electrochemical cell, rather than a ducting solution where explosive gas is swept out of the vessel 401 via forced convection.

Referring now to FIG. 25A, during cell charging, hydrogen gas may be generated and fill the headspace 2405 below the lid 455. This gas mixture can be explosive at high enough levels of hydrogen. For safety and reliability, the electrochemical cell may reduce the likelihood that a potential ignition of hydrogen gas in the headspace 2405 may propagate to, or otherwise damage, neighboring electrochemical cells.

One approach to reducing the likelihood of ignition of hydrogen gas propagating to neighboring electrochemical cells, may be to reduce the size of the headspace 2405′ such that only a small amount of hydrogen gas may be present in the headspace 2405 at any time. Hydrogen may be vented out of the small volume of the headspace 2405′ through a vent port 2506 on one side of the electrochemical cell. Since pressure in the headspace 2405′ will equalize to the ambient pressure of the manifold fluidically coupled to the vent port 2506, the % hydrogen per headspace area remains constant. Therefore, by reducing headspace area, the amount of hydrogen available for a combustion event is reduced.

Referring now to FIG. 25C, in some embodiments, the lid 455 may act as a pressure relief disk. One way to minimize the maximum pressure experienced by the electrochemical cell 400 may be to incorporate one or more pressure relief features that open at a predetermined pressure. This may reduce the likelihood that the electrochemical cell may exceed this predetermined pressure value. The lid 455 may have a large surface that has a small bond line with the vessel 401. The bond line may fail at a predetermined pressure, as may be useful for controlling the failure mode during a hydrogen event. Because the lid 455 is above the electrolyte level and is perpendicular to all neighboring electrochemical cells, a failure of this small bond line between the lid 455 and the vessel 401 would be unlikely to cause electrolyte loss or damage to neighboring electrochemical cells.

Referring now to FIG. 25D, in various embodiments, TPE sealing features of the lid 455 may function as knockout vents. One technique for sealing busbars to the lid 455 includes the use of flexible thermoplastic elastomer (TPE) features, such as the bellows 1105. The stress at which these flexible features fail may be much lower than the failure stress associated with the hard thermoplastic that may make up the rest of the vessel of the electrochemical cell. By designing these TPE features to fail at a certain headspace pressure, the failure mode and maximum pressure during a hydrogen ignition event may be controlled. Since these TPE features are above the electrolyte level and perpendicular to all neighboring electrochemical cells, a failure at these points would be unlikely to cause any electrolyte loss or damage to neighboring electrochemical cells.

Referring now to FIG. 25E, in various embodiments, multiple headspaces may be provided to facilitate managing hydrogen gas events. By limiting the amount of hydrogen gas present at the point of ignition, the maximum pressure during the ignition event may be minimized or at least controlled. Using the lid 455 to define separate cavities 2503 within the vessel 401, may limit the amount of hydrogen available for ignition to a single, smaller, headspace section. These separate cavities 2503 may completely contain the pressure event. Alternatively, these separate cavities 2503 may allow for propagation between the separate cavities 2503, which would result in multiple ignition events but with a decreased maximum pressure (compared to a single ignition event in the nominal headspace volume) spread out over a longer period of time.

Referring now to FIGS. 25F and 25G, gas may be funneled into specific spaces to manage hydrogen gas events. For example, by funneling the generated hydrogen gas into an area that does not contain busbars or other ignition sources, the probability of a hydrogen-related pressure event may be dramatically decreased along with the amount of hydrogen available for combustion in the headspace. By utilizing a floating surface 2508 that is impermeable to hydrogen, the electrolyte level may be able to change over the charge/discharge cycle of the electrochemical cell without changing headspace volume available to the hydrogen.

Referring now to FIG. 25H, to manage hydrogen gas events, the vessel 401 may be reinforced to survive a maximum pressure associated with a hydrogen ignition event. Reinforcing the vessel 401 to survive the maximum pressure generated during a hydrogen ignition event may reduce the likelihood that the hydrogen ignition may impact surrounding electrochemical cells.

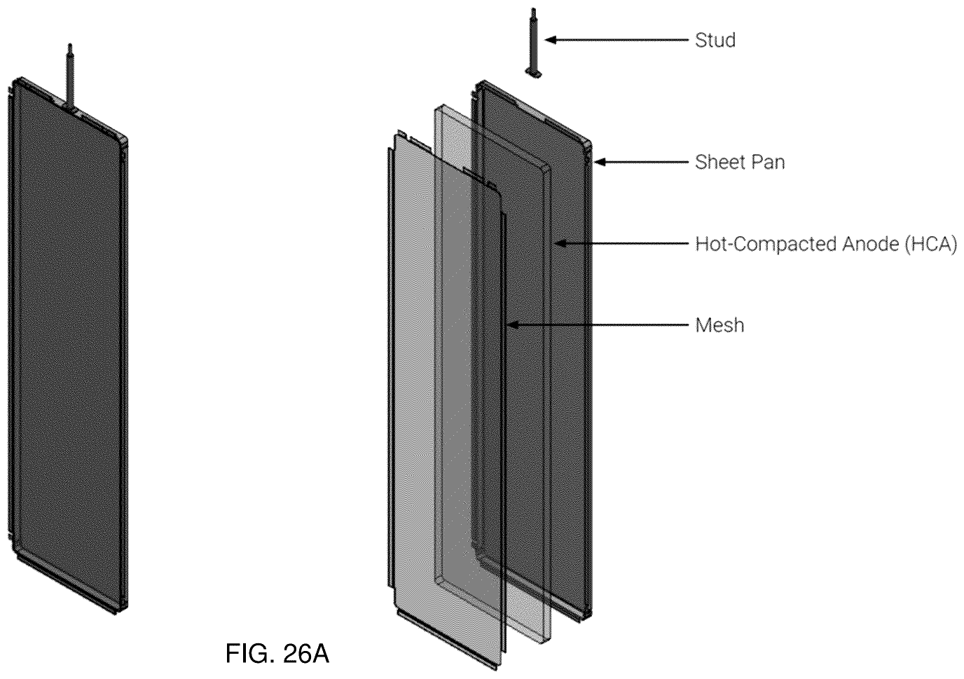

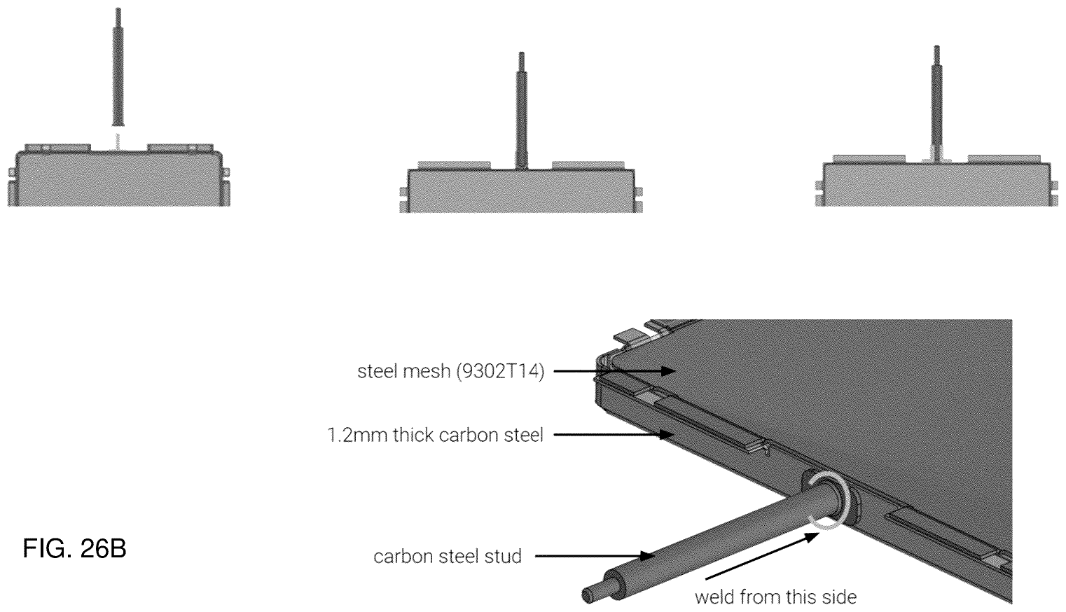

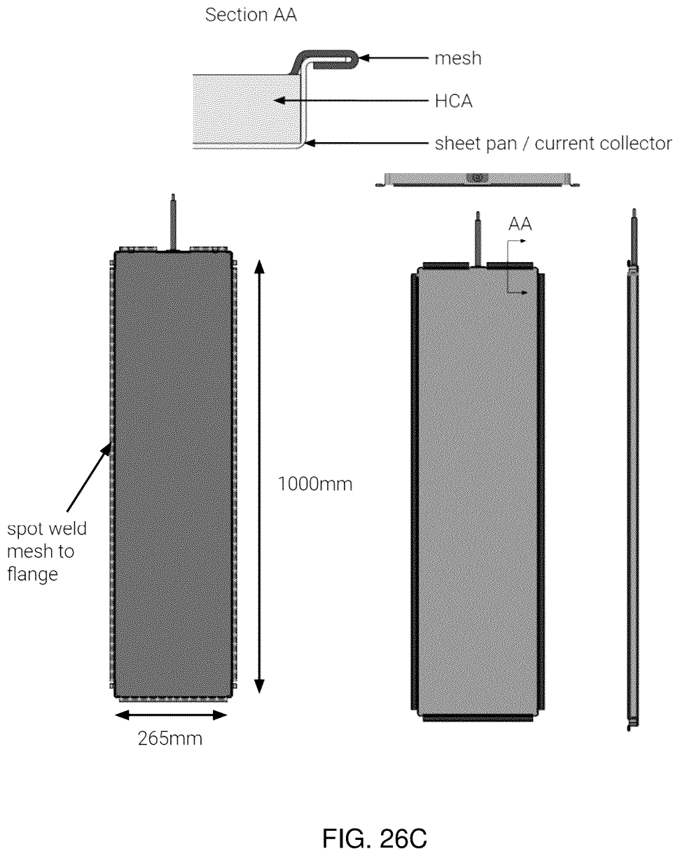

FIGS. 26A-C are schematic representations of aspects of anode assemblies (e.g., the first anode assembly 402a and/or the second anode assembly 402b in FIG. 4B).

Referring now to FIG. 26A, an anode assembly may be a hot compressed anode (HCA) structure. Structure and current collector of the HCA structure may be made of sheet metal stamped in a “pan-like” shape, with the solid backing facing away from the cathodes in the electrochemical cell. Busbars may be welded to the top-most edge of the sheet pan. Advantages of such “sheet pan” designs may include: that the pan may be pre-filled (prior to pressing & sintering) with anode material (e.g. powdered iron, DRI, additives) without a secondary form; that the back of pan may be nonporous, which may be beneficial for electrical conductivity (vs perforated or expanded); that solid steel sheet backing & sides may protect the anode assembly from handling-related damage; and/or that the solid top may provide a surface for welding busbars.

Referring now to FIG. 26B, a busbar may be attached to the top of the pan to pass current from the electrode through the lid. A round low-carbon steel busbar may be used because it is: easily welded to the pan (like metals); a relatively low-cost conductor (on par with Cu conductors); electrochemically compatible at anode potentials, therefore does not need to be encapsulated; structurally robust for lifting and moving the anode and the electrochemical cell; and easily sealed at the lid with mechanical seals (e.g. gasket & hose clamp). Methods of busbar attachment may include: resistance stud welding; threaded rod+nut in the sheet pan; and/or spot welding to tabs on the sheet pan.

Referring now to FIG. 26C, mesh/containment attachments for an anode may include a porous steel sheet (typically perforated or expanded) to contain any >1 mm sized particles of the anode which may become dislodged. These particles may cause shorts or clogs in the watering system.

The chemical reaction within an alkaline electrochemical cell may result in electrolyte mist populating the cell headspace. This mist can lead to conductive electrolyte working its way out of the cell and contaminating the surrounding area. To reduce the likelihood of this creep, creating a hermetic seal between the lid and the vessel may be critical to the functionality of the electrochemical cell. However, creating this seal may be difficult due to the length of the seam.

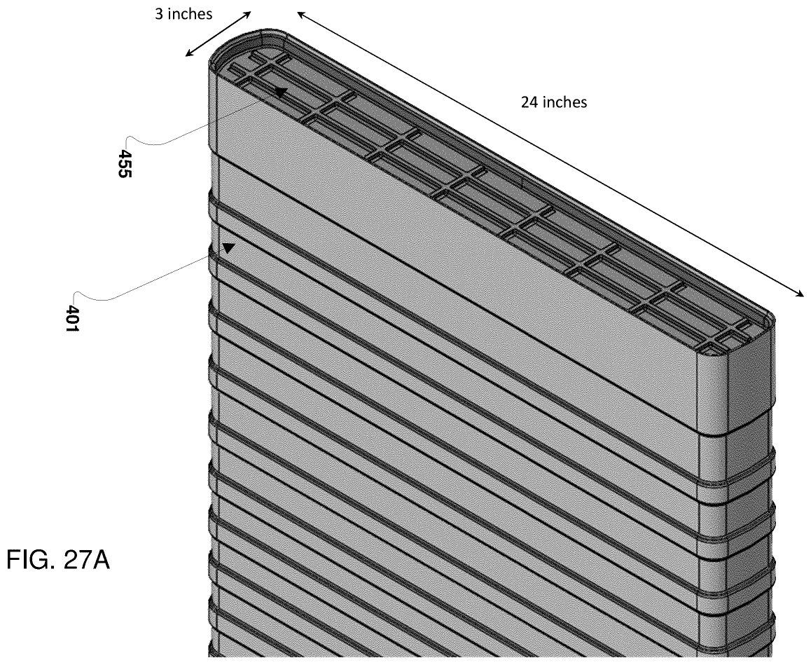

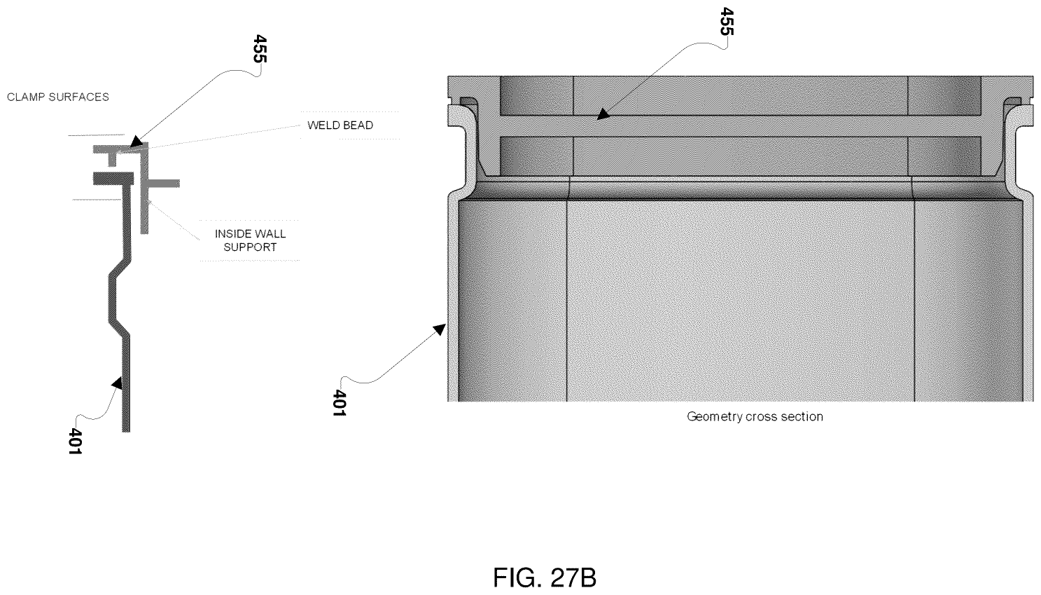

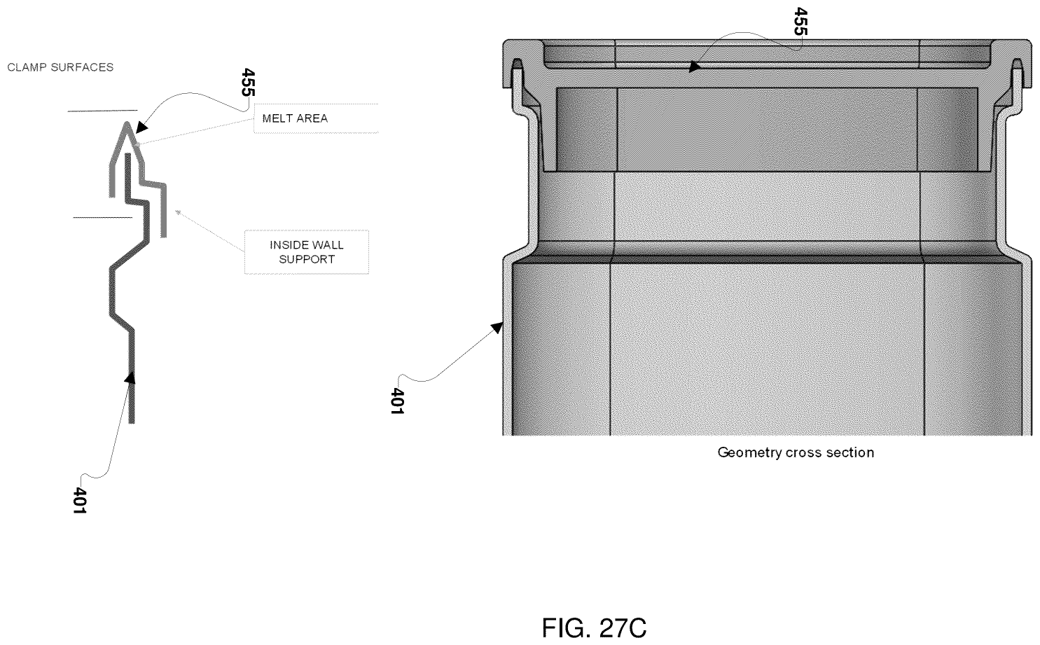

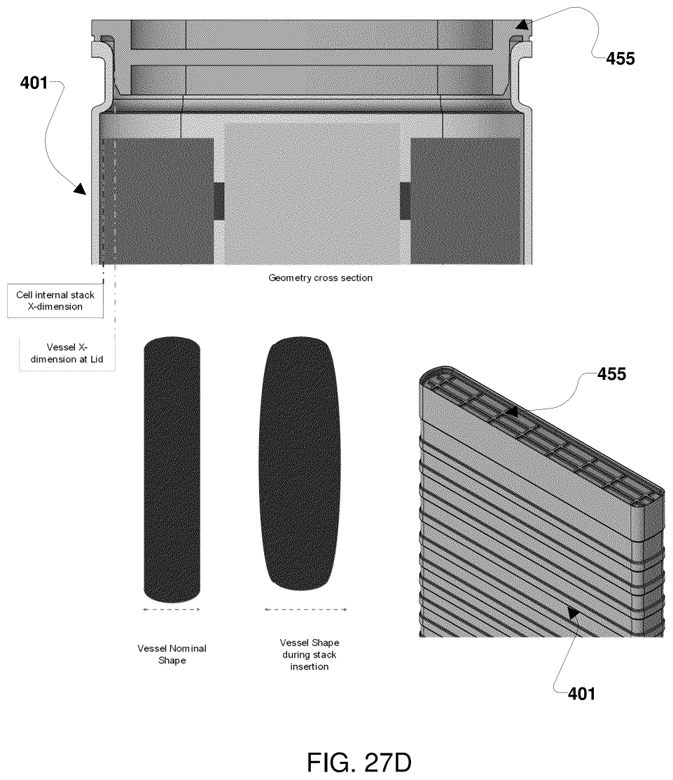

FIGS. 27A-D are schematic representations of aspects of lid-to-vessel sealing (e.g., sealing the lid 455 to the vessel 401 in FIG. 4B).

Referring now to FIG. 27A, the seal between the lid 455 and the vessel 401 may need to be able to account for large dimensional tolerances between the lid and the vessel due to the size of the two parts and/or the use of the lower tolerance manufacturing methods (blow molding) for cost-effective fabrication of the vessel. Clamping force needed between the lid 455 and the vessel 401 during the sealing process may need to be isolated from the walls of the vessel 401 (e.g., in instances in which the walls of the vessel 401 are too flimsy) and/or from other components of the electrochemical cell subcomponents. Further, or instead, features of the seal between the lid 455 and the vessel 401 may need to fit within the existing X, Y, and Z bounding box of the vessel 401.

Referring now to FIG. 27B, welding (e.g., hot gas welding or laser welding) may be used to seal the lid 455 to the vessel 401. Notable features of such an implementation may include: a weld bead to make up for any tolerancing between the two parts; a flange in the vessel 401 providing a clamping surface to decrease the likelihood that any clamping during the weld process propagates to the vessel 401; inside support wall on the lid 455 reducing the likelihood of the vessel 401 slipping during a weld process; and increased thickness of the vessel 401 at the flange point. Minimizing thickness of the vessel 401 may be critical to reducing inactive material cost of the cell. Because of this, the nominal wall thickness of the vessel 401 may be thinner than optimal for welding. By utilizing parison programming during the blow mold process, the vessel thickness may be increased in a specific height window of the vessel 401. Datuming to the top flange of the vessel 401 instead of to the bottom of the vessel 401 may remove, or at least decrease, the need for tight tolerancing on the height of the vessel 401, which may be about 1 m in some instances.

Referring now to FIG. 27C, the lid 455 may be sealed to the vessel 401 using a hot gas welding joint geometry. Notable features of such a hog gas welding joint geometry may include: the angular opening that allows for a large displacement of the top edge of the vessel 401 to account for any lack of tolerancing on that surface; the flange in the vessel 401 provides a clamping surface to reduce the likelihood of unintended propagation of clamping force down into the vessel 401; the inside support wall on the lid 455 may reduce the likelihood of the vessel 401 slipping during the weld process; and datuming to the top flange of the vessel 401 instead of to the bottom of the vessel 401 may remove, or at least decrease, the need for tight tolerancing on the height (e.g., about 1 m) of the vessel 401.

Referring now to FIG. 27D, the vessel 401 may include flexible walls to facilitate achieving large available overlap between the lid 455 and the vessel 401. Utilizing the flexible walls of the vessel 401 to achieve large available overlap between the lid 455 and the vessel 401 may be applicable to all weld geometries described herein, such as those of FIG. 27B and FIG. 27C. To facilitate optimizing footprint of the electrochemical cell, the bounding dimensions of the electrochemical cell may be driven by the dimensions of the substack (anodes+cathodes) of the electrochemical cell, with the additional area being allocated only for vessel wall thickness and cooling channels. The overlap surface between the flange of the vessel 401 and the lid 455 may be too small for reliable plastic welding. By utilizing the flexibility of the vessel 401, it may become possible to have a nominal interference between the substack and atop section of the vessel 401, as the vessel 401 can be deformed during the insertion process to allow the substack to slide in.

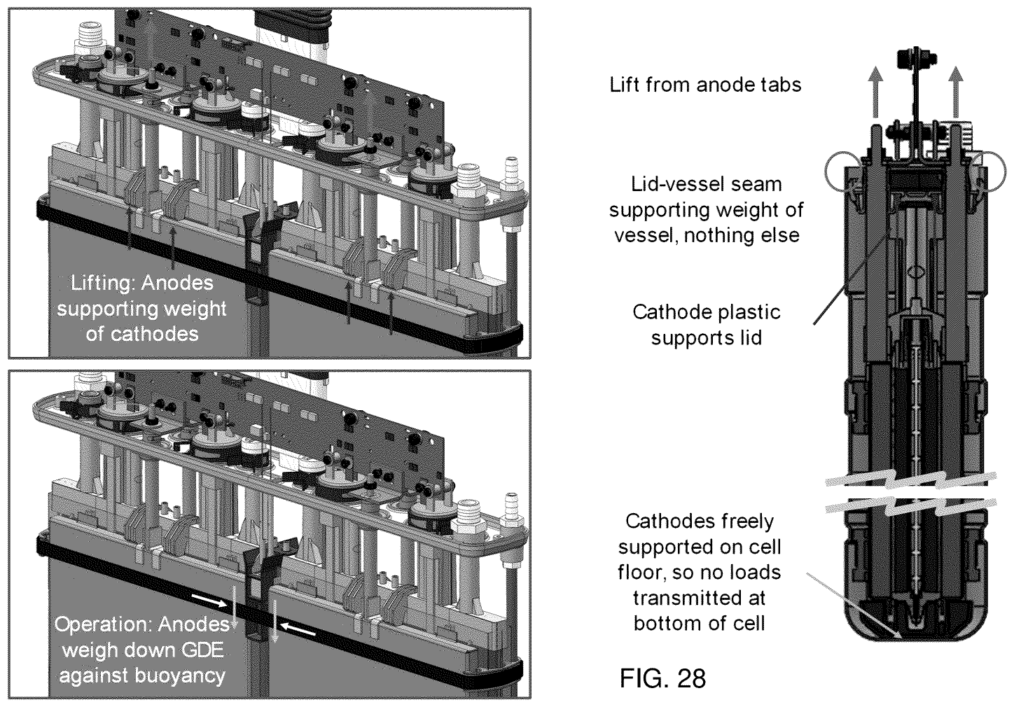

Referring now to FIG. 28, an anode (e.g., the first anode assembly 402a and/or the second instances of the second anode assembly 402b in FIG. 4B) may operate as a primary structural member for an electrochemical cell. That is, the anodes of an electrochemical may serve as the structural backbone of the electrochemical cell due to mass and rigidity relative to the other cell components. Reducing materials cost means reducing materials, and not all components and seals are capable of withstanding forces seen during lifting or operation. In the case of lifting, the electrochemical cell may be lifted by the anodes, the anodes may support the weight of cathodes through features on plastic parts of the cathode. The lid may be supported by cathode plastics, and only the vessel-to-lid seam must withstand the weight of the vessel. During operation, the weight of the anodes may counteract buoyancy force in the GDE through friction between the anodes and cathode plastics. Strapping may constrain anodes to plastics. Resulting friction to GDE plastics counteracts buoyant force.

Minimizing or reducing the inactive material used in each electrochemical cell may help to decrease the system cost without losing any performance. A typical vessel of the electrochemical cell serves the dual purposes of isolating cells from one another and providing the structure to hold the shape of the electrochemical cell. The amount of material needed to fulfill this functionality can result in large costs associated with inactive material.

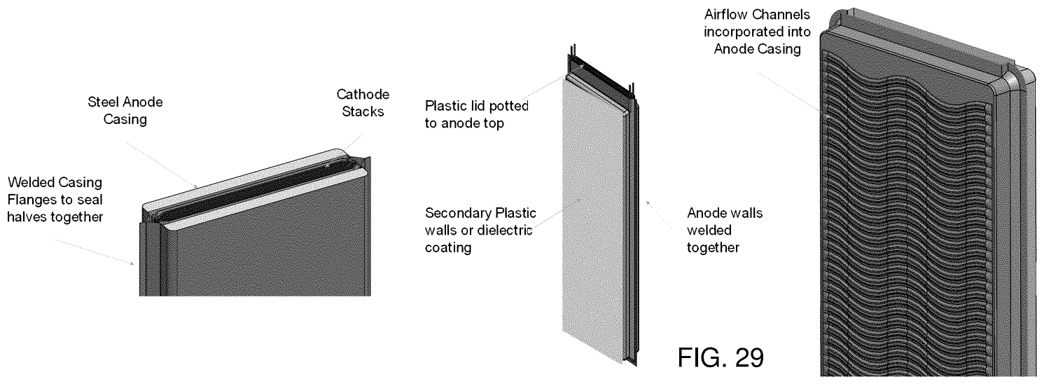

Referring now to FIG. 29, schematic representations of aspects of anodes used as cell containers are shown. The anode may include a metal, such as iron, encased in a steel pan. Utilizing the structure of the anode to fulfill the structural functionality of the vessel of the electrochemical cell, instead of relying on a separate vessel to house all of the components, may remove a large amount of inactive material from the electrochemical cell. A dielectric coating may be applied to the steel anode casing to provide electrical insulation. Cooling channels may be incorporated into the stamped vessel to fulfill thermal system airflow requirements. This may facilitate reducing costs associated with inactive cell material and part manufacturing.

Various embodiments may include blow mold designs for module cooling and structure. In various embodiments, the vessel of the electrochemical cell, may have a geometry that facilitates achieving required cell cooling. Further, or instead, the vessel may electrically insulate the electrochemical cell. The vessel may be alkaline electrolyte compatible. The vessel may define a cavity that is hermetically sealed. The vessel may withstand forces acting on the vessel, such as with a safety factor of 1.5. The vessel may restrain hydrostatic forces from the liquid electrolyte. The vessel may accommodate airflow for cooling.

In various embodiments, a vessel of the electrochemical cell may include a cooling channel geometry that changes with cell height to facilitate directing more cooling towards the top of the electrochemical cell, where the electrolyte tends to be hotter due to natural convection. Further, or instead, the changing cooling channel geometry may maximize vessel wall strength towards the bottom of the electrochemical cell where the hydrostatic loads are higher. In such embodiments, the vessel may be a multifunctional component, delivering mechanical structure, thermal cooling channels, and/or electrolyte containment.

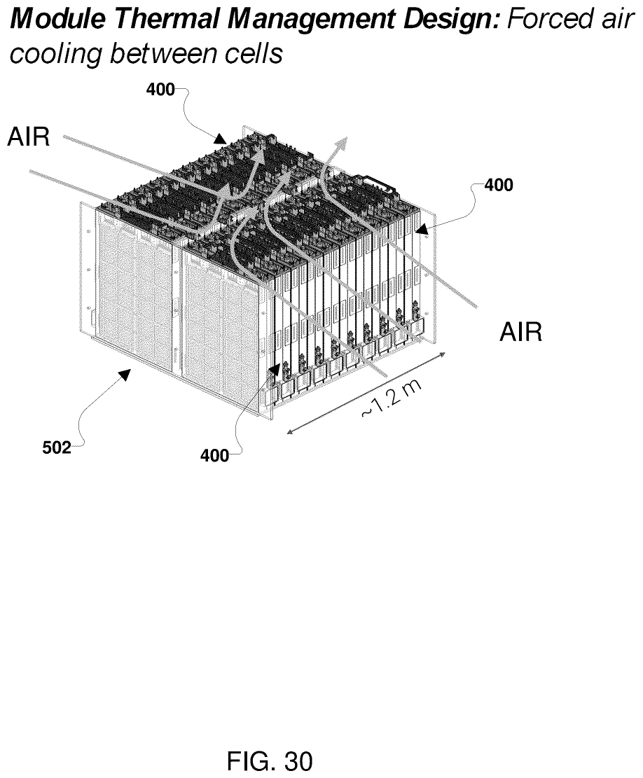

FIG. 30 is a schematic representation of thermal management of a module using forced air cooling between electrochemical cells. In some implementations, forced air cooling between vessels of electrochemical cells may be achieved by moving air along the faces of the vessels toward a center of a module of the electrochemical cells.

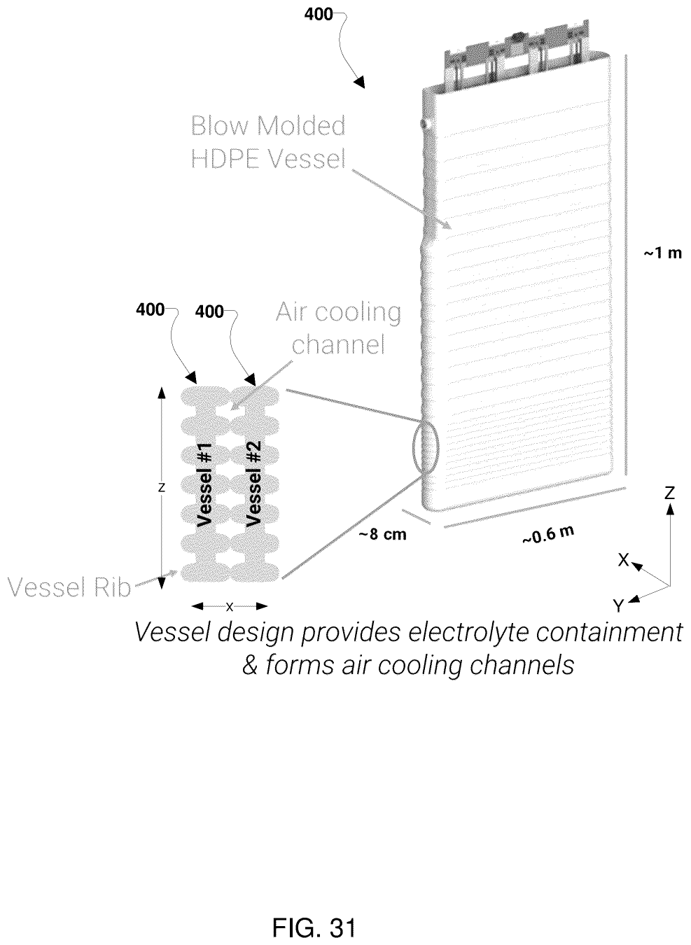

FIG. 31 is a schematic representation of aspects of a vessel of an electrochemical cell. The vessel of the electrochemical cell may be blow molded high density polyethylene (HDPE) that provides electrolyte containment and defines air cooling channels between adjacent instances of the vessel when multiple instances of the vessel are arranged width face to width face (i.e., y dimension to y dimension) in a module, such as shown in the module 502 (FIG. 5B). The ribs on the vessels may physically interact with one another to define air cooling channels therebetween as shown in the y-axis view exploded diagram portion of FIG. 31.

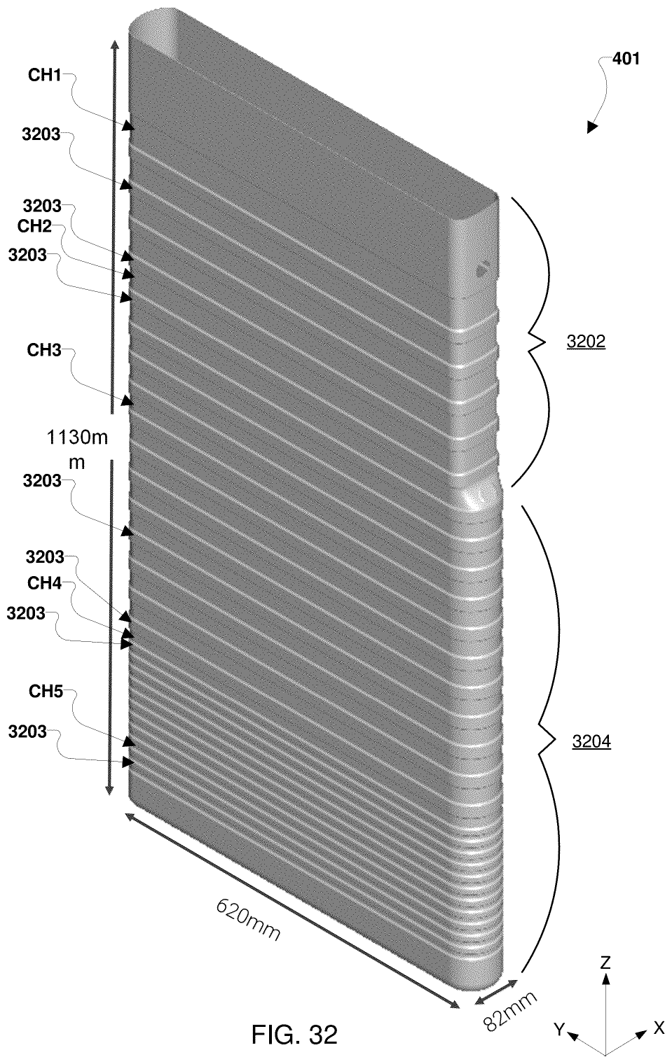

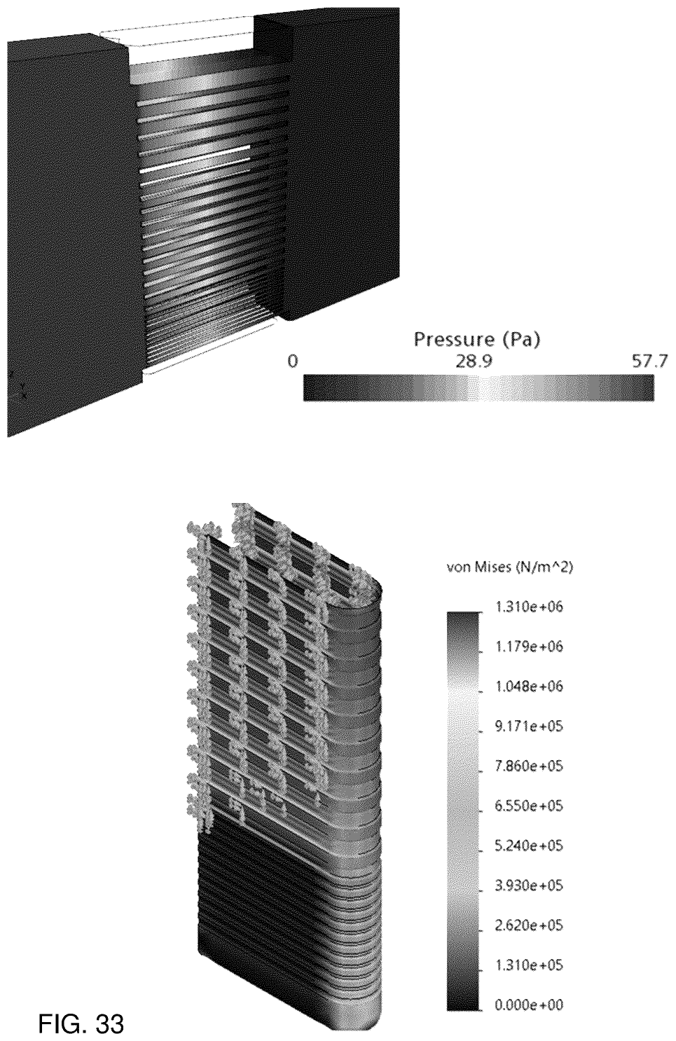

FIG. 32 is a perspective view of a blow molded vessel of an electrochemical cell, and FIG. 33 shows computational fluid dynamics/finite element analysis simulation results of air flow across the blow molded cell vessel of FIG. 32. The material of the vessel 401 may be any suitable material, such as HDPE, acrylonitrile butadiene styrene (ABS), polypropylene (PP), polyethylene terephthalate (PET), etc. The vessel 401 may be manufactured by blow molding. As an example, the vessel 401 may have a nominal wall thickness of 1.5 mm. Additionally, or alternatively, the vessel may be dimensioned and otherwise formed to have a lifetime of at least 20 years while filled with caustic electrolyte. The vessel 401 may withstand a hydrostatic loading of 15 kPa at the bottom of the vessel. The vessel 401 may be configured to survive an ambient temperature range of −30° C. to 40° C. In various embodiments, the vessel 401 may have a series of ribs 3203 spaced apart by channels of varying channel heights (e.g., CH1, CH2, CH3, CH4, CH5, etc.) between successive instances of the ribs 3203. The geometry of the vessel 401 may change with the height of the vessel 401 to meet airflow requirements and space constraints while accounting for increasing hydrostatic loads with electrolyte depth within the vessel 401. For example, the channel heights CH1-CH5 may range from 8 mm at the bottom of the vessel 401 to 35 mm at the top of the vessel 401 to provide wall strength at the bottom and cooling area at the top. The vessel 401 may include an indent 3202 towards the top of the vessel 401 to provide space for the watering system. The full radius 3204 at the bottom of the vessel 401 may reduce wall stresses. The ribs 3203 of the vessel 401 may define a plurality of channels that are parallel to one another and may circumscribe the vessel 401. The pressure drop across the vessel in the parallel flow configuration may be less than or equal to 150 Pa and computational fluid dynamic/finite element analysis indicates that the pressure drop may be 58 Pa, the requirement for maximum temperature of the vessel may be less than or equal to 45° C. and computational fluid dynamic/finite element analysis indicates that the maximum temperature of the vessel may be 39° C., and the requirement for maximum wall stress may be less than or equal to 1.2 MPa and the finite element analysis results indicate that the max wall stress may be 1.1 MPa.

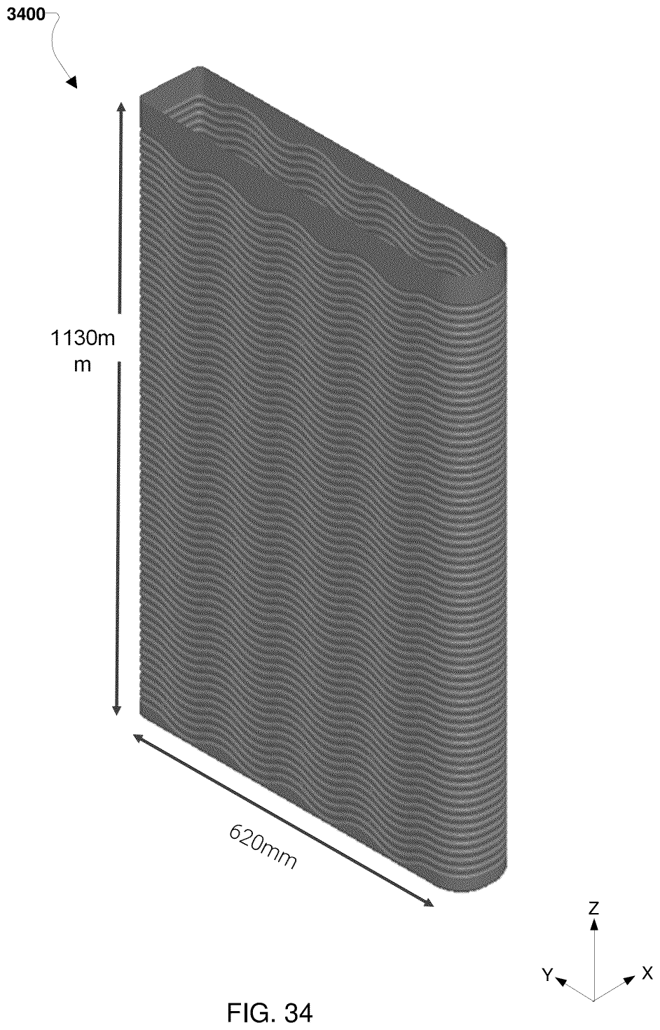

FIG. 34 is a perspective view of a vessel 3400 defining curved channels. The vessel 3400 may be similar to the vessel 401 (FIG. 4A) except the vessel 3400 may define curved channels. Inverted curve directions for the channels on each side of the vessel 3400 may reduce the likelihood of interference with the channels of neighboring electrochemical cells when the electrochemical cells are arranged in a module.

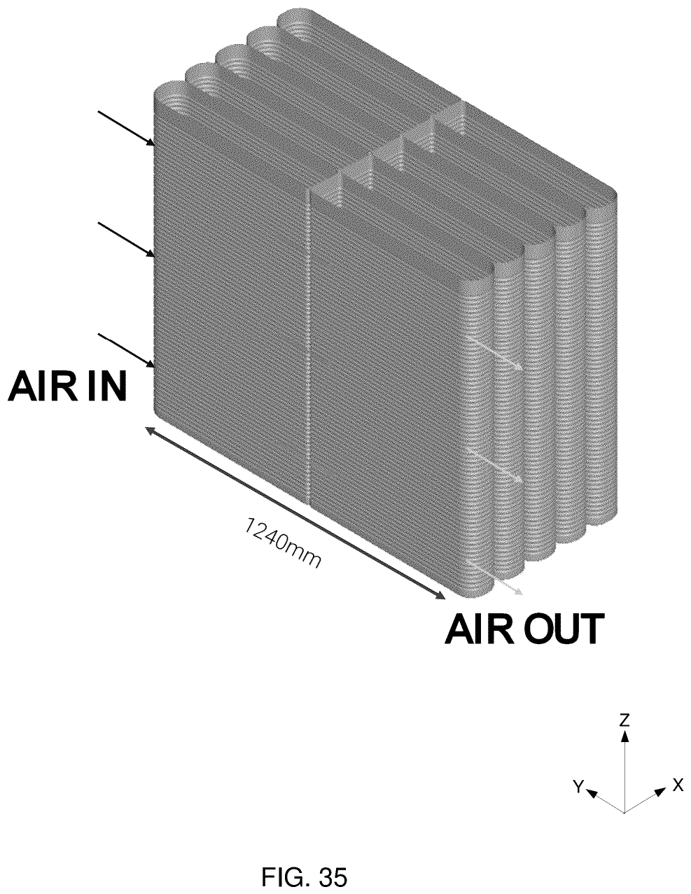

FIG. 35 is a schematic representation of serial airflow across a module of electrochemical cells. In such implementations, air may be pulled across both rows of the electrochemical cells of the module instead of being pulled to the center of the module. This may save space and reduce (e.g., by half) the number of plenums needed per skid of the modules.

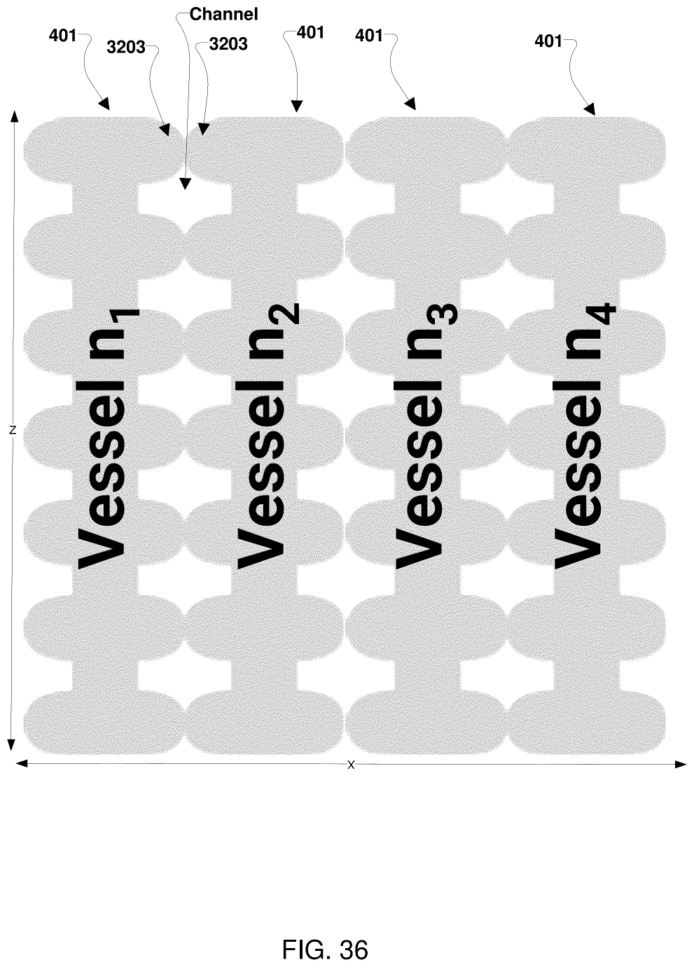

FIG. 36 is a schematic representation of a parallel flow configuration of stacked instances n1-n4 of the vessel 401 in a row within a module (such as module 502 in FIG. 5B). The wide faces—those extending in the y-dimension—may be arranged toward one another. Multiple instances of the vessel 401 may be stacked mechanically in a row, within external support structures of a module. The vessel 401 may support the liquid pressure load on the sidewall of the vessel 401 when a plurality of instances of the vessel 401 are packed adjacent to one another. The plurality of instances of the vessels 401 may be stacked in a row having any length, providing flexibility in the string length of the electrochemical cells of a module. Individually, the electrochemical cell may be unable to stand on its own and/or would experience side wall deflection when filled with electrolyte. In a module assembly, however, each instance of the vessel 401 may be stabilized by the adjacent instances of the vessel 401 and/or by the module-level mechanical structure. The ribs 3203 of the vessel 401 may support the mechanical load or pressure exerted by the adjacent instances of the vessel 401. This mechanical architecture may facilitate meeting mechanical design requirements with a low amount of inactive material and low material cost.

The material of the vessel 401 may be any suitable material, such as HDPE, ABS, polypropylene, PET, etc. HDPE may be low cost and electrolyte compatible. ABS may be easy to bond, weldable, and electrolyte compatible. Polypropylene may be low cost and electrolyte compatible. PET may have a high strength-to-cost ratio.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. An electrochemical cell comprising:
a vessel;
at least two instances of an anode assembly;
at least two instances of an oxygen evolution electrode (OEE); and
a gas diffusion electrode (GDE) wherein, in the vessel, the GDE is disposed between mirrored arrangements of the at least two instances of the OEE and the at least two instances of the anode assembly.

2. The electrochemical cell of claim 1, wherein, from one side of the vessel to another side of the vessel, the mirrored arrangements include a first instance of the anode assembly, a first instance of the OEE, the GDE, a second instance of the OEE, and a second instance of the anode assembly.

3. The electrochemical cell of claim 1, wherein, from one side of the vessel to another side of the vessel, the mirrored arrangements include a first instance of the OEE, a first instance of the anode assembly, the GDE, a second instance of the anode assembly, and a second instance of the OEE.

4. The electrochemical cell of claim 1, further comprising an electrolyte disposed in the vessel, wherein the at least two instances of the anode assembly, the at least two instances of the OEE, and the gas diffusion electrode are each at least partially immersed in the electrolyte in the vessel.

5. The electrochemical cell of claim 1, wherein the vessel includes a lid including a nested trough, bellows, a flange seal, a hot welded joint, and/or a laser welded joint.

6. The electrochemical cell of claim 1, wherein the GDE defines an air passage between two faces of the GDE.

7. The electrochemical cell of claim 1, wherein the GDE is a bifacial electrode sealed on three edges, and the bifacial electrode includes two electrode sheets and a flow field therebetween.

8. The electrochemical cell of claim 7, wherein the flow field includes a stack of varying porosity foam, strips of filter felt, serpentine channels, folded channels, or a combination thereof.

9. The electrochemical cell of claim 7, wherein the flow field mechanically and electrically separates two faces of the bifacial electrode.

10. The electrochemical cell of claim 7, further comprising a bag of separator material, a one or more standoffs, and/or an electrode holder supporting the at least two instances of the anode assembly, the GDE, and the at least two instances of the OEE in the vessel.

11. The electrochemical cell of claim 1, wherein the vessel includes an electronics structure providing distributed electrode switching.

12. The electrochemical cell of claim 1, wherein the vessel includes a cell demisting structure and/or a flame arrestor structure associated with a headspace of the vessel.

13. The electrochemical cell of claim 1, wherein the at least two instances of the anode assembly include metal stamped sheets.

14. The electrochemical cell of claim 1, wherein the at least two instances of the anode assembly, the at least two instances of the OEE, and the GDE are each constrained from moving relative to one another in the vessel.

15. The electrochemical cell of claim 1, wherein outer walls of the vessel are formed by the at least two instances of the anode assembly.

16. The electrochemical cell of claim 1, wherein the vessel includes a plurality of ribs on outer walls of the vessel, the plurality of ribs spaced apart from one another to define a plurality of channels between successive ribs.

17. The electrochemical cell of claim 16, wherein the plurality of channels are of different heights ranging from a smaller height at a bottom portion of the vessel to a larger height at a top portion of the vessel.

18. The electrochemical cell of claim 16, wherein the vessel is formed from blow molded high density polyethylene (HDPE), acrylonitrile butadiene styrene (ABS), polypropylene (PP), or polyethylene terephthalate (PET).

19. The electrochemical cell of claim 1, wherein the vessel is a bag physically supported by a module into which the electrochemical cell is insertable.

20. The electrochemical cell of claim 1, further comprising a separator, wherein the separator is a sheet disposed between one instance of the OEE and the GDE and/or between one instance of the OEE and one instance of the anode assembly.

21. The electrochemical cell of claim 20, wherein the sheet is supported on one instance of the OEE.

22. The electrochemical cell of claim 1, wherein the electrochemical cell is an iron-air type battery cell, zinc-air type battery cell, and/or lithium-air battery cell.
